(19) United States
(12) Patent Application Publication
(10) Pub. No.: US 2026/0319883 A1
(43) Pub. Date: Oct. 15, 2026

(54) TRANSMISSION DEVICE AND RECEPTION DEVICE

(71) Applicant: Mitsubishi Electric Corporation, Chiyoda-ku, Tokyo (JP)

(72) Inventors: Shunsuke AKASAKA, Tokyo (JP); Masashi ASUKA, Tokyo (JP); Tadashi YAMAMOTO, Tokyo (JP); Rie INUI, Tokyo (JP)

(73) Assignee: Mitsubishi Electric Corporation, Chiyoda-ku, Tokyo (JP)

(21) Appl. No.: 19/485,455

(22) PCT Filed: May 15, 2024
(86) PCT No.: PCT/JP2024/017914

§ 371 Date: Nov. 18, 2025

(30) Foreign Application Priority Data
May 26, 2023 (WO) PCT/JP2023/019650

(51) Int. Cl. G06F 11/10

(52) U.S. Cl. CPC G06F 11/1004

(57) ABSTRACT

A transmission device includes: a computer including a calculation unit that calculates first data by performing a calculation on an input signal, and a checksum calculation unit that calculates a first checksum by performing a calculation on the first data; a computer including a calculation unit that calculates second data by performing a calculation on the input signal; and a transmission unit that transmits the first checksum and the second data to a reception device.

### FIELD

The present disclosure relates to a transmission device and a reception device for transmitting data.

### BACKGROUND

Conventionally, computer systems that handle important data adopt configurations in which a computer is duplicated and results of the computers are compared in the event of some malfunction in one computer as hardware so that the influence of the malfunction does not affect an output from the computer. The computer system compares the results of the computers and adopts the results obtained by the computers only when the results match. An example of a method of comparing the results of the computers is to compare the results of the computers on a bit-by-bit basis, but in the method of comparing the results of the computers on a bit-by-bit basis, the circuit scale increases as the data amount increases.

In view of such a problem, Patent Literature 1 discloses a technique in which, in a system including two counters, a parity generator outputs a parity bit signal according to a logical state of each output from one counter, and a parity check circuit performs parity matching between the output from the other counter and the parity bit signal, thereby simplifying the circuit and comparing the outputs from the two counters.

### CITATION LIST

### Patent Literature

Patent Literature 1: Japanese Patent Application Laid-open No. S55-95155

### SUMMARY OF INVENTION

### Problem to be Solved by the Invention

However, according to the above-described conventional technique, although the counter is duplicated, there is a problem in that an erroneous output from the counter may be used due to a single fault of the parity check circuit.

The present disclosure has been made in view of the above, and an object thereof is to obtain a transmission device capable of transmitting, to a reception device, information that can easily detect a failure in duplicated data calculation occurring in the transmission device.

### Means to Solve the Problem

In order to solve the above-described problems and achieve the object, a transmission device according to the present disclosure includes: a first computer including a first calculation unit to calculate first data by performing a calculation on an input signal, and a first checksum calculation unit to calculate a first checksum by performing a calculation on the first data; a second computer including a second calculation unit to calculate second data by performing a calculation on the input signal; and a transmission unit to transmit the first checksum and the second data to a reception device.

### Effects of the Invention

The transmission device according to the present disclosure can achieve the effect of transmitting, to the reception device, information that can easily detect a failure in the duplicated data calculation occurring in the transmission device.

### BRIEF DESCRIPTION OF DRAWINGS

FIG. 1 is a diagram illustrating an exemplary configuration of a communication system according to the first embodiment.

FIG. 2 is a flowchart illustrating the operation of the transmission device according to the first embodiment.

FIG. 3 is a flowchart illustrating the operation of the reception device according to the first embodiment.

FIG. 4 is a diagram illustrating an exemplary configuration of processing circuitry in the case that the processing circuitry provided in the transmission device according to the first embodiment is implemented by a processor and a memory.

FIG. 5 is a diagram illustrating an example of processing circuitry in the case that the processing circuitry of the transmission device according to the first embodiment is implemented by dedicated hardware.

FIG. 6 is a diagram illustrating an exemplary configuration of a communication system according to the second embodiment.

FIG. 7 is a flowchart illustrating the operation of the transmission device according to the second embodiment.

FIG. 8 is a flowchart illustrating the operation of the reception device according to the second embodiment.

FIG. 9 is a diagram illustrating an exemplary configuration of a communication system according to the third embodiment.

FIG. 10 is a flowchart illustrating the operation of the transmission device according to the third embodiment.

FIG. 11 is a flowchart illustrating the operation of the reception device according to the third embodiment.

FIG. 12 is a diagram illustrating an exemplary configuration of a communication system according to the fourth embodiment.

FIG. 13 is a flowchart illustrating the operation of the transmission device according to the fourth embodiment.

FIG. 14 is a flowchart illustrating the operation of the reception device according to the fourth embodiment.

FIG. 15 is a diagram illustrating an exemplary configuration of a communication system according to the fifth embodiment in which the first computers included in the transmission device of the first embodiment are configured in a redundant manner.

FIG. 16 is a diagram illustrating an example of a data frame including N first checksums and one piece of second data transmitted from the transmission device of the communication system to the reception device according to the fifth embodiment.

FIG. 17 is a diagram illustrating an exemplary configuration of a communication system according to the fifth embodiment in which the first computers included in the transmission device of the second embodiment are configured in a redundant manner.

FIG. 18 is a diagram illustrating an exemplary configuration of a communication system according to the fifth embodiment in which the first computers included in the transmission device of the third embodiment are configured in a redundant manner.

FIG. 19 is a diagram illustrating an exemplary configuration of a communication system according to the fifth embodiment in which the first computers included in the transmission device of the fourth embodiment are configured in a redundant manner.

FIG. 20 is a diagram illustrating an example of a data frame including N first checksums and one piece of second data transmitted from the transmission device of the communication system to the reception device according to the sixth embodiment.

FIG. 21 is a diagram illustrating an exemplary configuration of a communication system according to the seventh embodiment.

FIG. 22 is a diagram illustrating an exemplary configuration of a communication system according to the eighth embodiment.

### DESCRIPTION OF EMBODIMENTS

Hereinafter, a transmission device and a reception device according to embodiments of the present disclosure will be described in detail with reference to the drawings.

### First Embodiment.

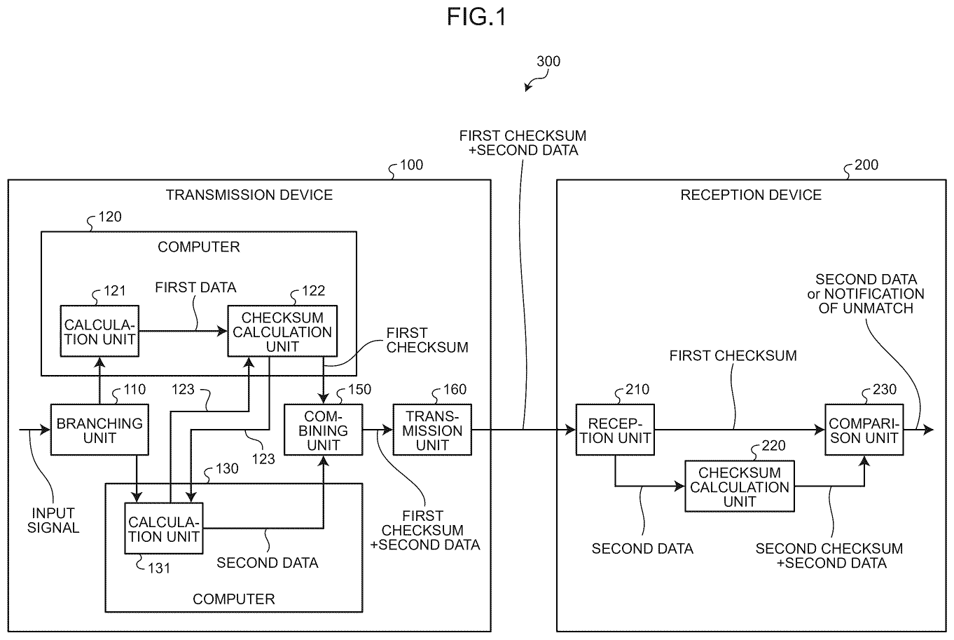

FIG. 1 is a diagram illustrating an exemplary configuration of a communication system 300 according to the first embodiment. The communication system 300 includes a transmission device 100 and a reception device 200. The communication system 300 is a system used in, for example, a train security device and is assumed to be used for inter-vehicle communication between a train and a ground facility, communication between ground facilities, and the like, but the application of the communication system 300 is not limited thereto.

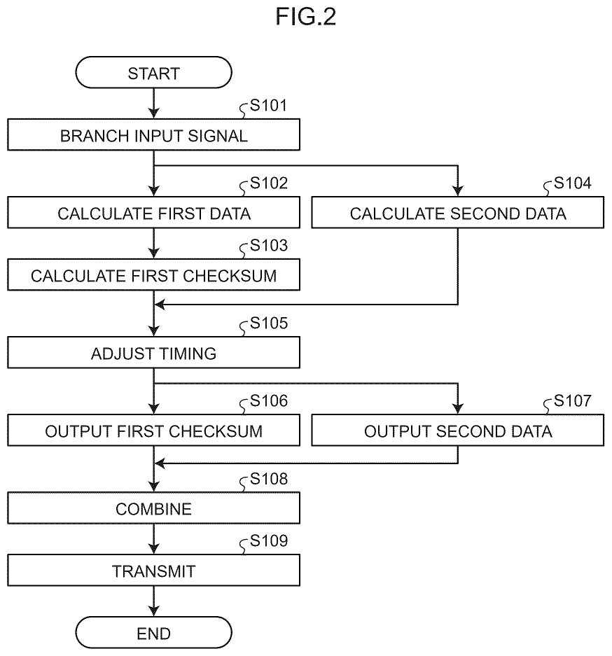

First, the configuration and operation of the transmission device 100 will be described. As illustrated in FIG. 1, the transmission device 100 includes a branching unit 110, a computer 120, a computer 130, a combining unit 150, and a transmission unit 160. The computer 120 includes a calculation unit 121, a checksum calculation unit 122, and a timing adjustment interface 123. The computer 130 includes a calculation unit 131. The timing adjustment interface 123, which is included in the computer 120, is an interface used between the computer 120 and the computer 130 as illustrated in FIG. 1. Therefore, the timing adjustment interface 123 may be included in the computer 130 or may be included in both the computer 120 and the computer 130. Furthermore, the timing adjustment interface 123 may be outside the computer 120 and the computer 130. As will be described later, the transmission device 100 has a configuration in which two computers 120 and 130 perform calculation on the same input signal, that is, the computers are duplicated. FIG. 2 is a flowchart illustrating the operation of the transmission device 100 according to the first embodiment.

The branching unit 110 branches an input signal to be calculated by the calculation unit 121 of the computer 120 and the calculation unit 131 of the computer 130 (step S101). The branching unit 110 outputs one input signal obtained by branching to the calculation unit 121 of the computer 120, and outputs the other input signal obtained by branching to the calculation unit 131 of the computer 130. The branching unit 110 may duplicate the acquired input signal and output the input signal to the calculation unit 121 of the computer 120 and the calculation unit 131 of the computer 130. The input signal may be generated inside the transmission device 100 or may be generated outside the transmission device 100.

In the computer 120, the calculation unit 121 is a first calculation unit that calculates first data by performing a prescribed calculation on the input signal (step S102) and outputs the first data to the checksum calculation unit 122. The checksum calculation unit 122 is a first checksum calculation unit that calculates a first checksum by performing a prescribed calculation on the first data (step S103) and outputs the first checksum to the combining unit 150. The first checksum is one of error detection codes and is calculated by a general calculation. The same applies to a second checksum described later. In the following description, the computer 120 may be referred to as a first computer.

In the computer 130, the calculation unit 131 is a second calculation unit that calculates second data by performing a prescribed calculation on the input signal (step S104) and outputs the second data to the combining unit 150. Here, the calculation method of the calculation unit 121 of the computer 120 and the calculation method of the calculation unit 131 of the computer 130 are the same. That is, given that both the calculation unit 121 of the computer 120 and the calculation unit 131 of the computer 130 normally perform calculation, the first data and the second data calculated from the same input signal have the same value. In the following description, the computer 130 may be referred to as a second computer.

The computer 120 outputs a signal for timing adjustment to the other computer 130 via the timing adjustment interface 123, and adjusts the timing at which the checksum calculation unit 122 of the computer 120 outputs the first checksum to the combining unit 150 and the timing at which the calculation unit 131 of the computer 130 outputs the second data to the combining unit 150 (step S105). Specifically, at the timing immediately before the checksum calculation unit 122 of the computer 120 outputs the first checksum to the combining unit 150 and the timing immediately before the calculation unit 131 of the computer 130 outputs the second data to the combining unit 150, the computers 120 and 130 mutually output a timing message, confirm reception of the timing message from the other party, and then adjust the output timings of the checksum calculation unit 122 of the computer 120 and the calculation unit 131 of the computer 130 so as to be within the same or a prescribed range of time difference. In this manner, the computers 120 and 130 adjust the timing at which the checksum calculation unit 122 outputs the first checksum and the timing at which the calculation unit 131 outputs the second data by using the timing adjustment interface 123.

The checksum calculation unit 122 of the computer 120 outputs the first checksum to the combining unit 150 according to the timing adjusted by the timing message (step S106). The calculation unit 131 of the computer 130 outputs the second data to the combining unit 150 according to the timing of the timing message output from the timing adjustment interface 123 (step S107).

The combining unit 150 combines the first checksum output from the checksum calculation unit 122 of the computer 120 and the second data output from the calculation unit 131 of the computer 130 (step S108). The combining unit 150 outputs the combined first checksum and second data to the transmission unit 160. The combining unit 150 combines the first checksum and the second data, assuming that the first checksum arriving from the checksum calculation unit 122 of the computer 120 and the second data arriving from the calculation unit 131 of the computer 130 within the same or a prescribed range of time difference are based on the same input signal. In a case where the first checksum and the second data cannot be acquired within the prescribed time difference range, the combining unit 150 may notify the user of the transmission device 100 or the like of the fact.

The transmission unit 160 transmits the first checksum and the second data to the reception device 200 (step S109). In the first embodiment, the transmission unit 160 transmits the first checksum and the second data combined by the combining unit 150 to the reception device 200. For example, in a case where the first data and the second data calculated by the calculation unit 121 of the computer 120 and the calculation unit 131 of the computer 130 are [0xc0 0xA8 0xFF 0x58], and the first checksum calculated by the checksum calculation unit 122 of the computer 120 is [0xBF], the combined first checksum and second data transmitted from the transmission unit 160 is [0xc0 0xA8 0xFF 0x58 0xBF]. Note that, here, the order of the combined first checksum and second data is the second data and the first checksum, but the order may be the first checksum and the second data as long as the order is known between the transmission device 100 and the reception device 200.

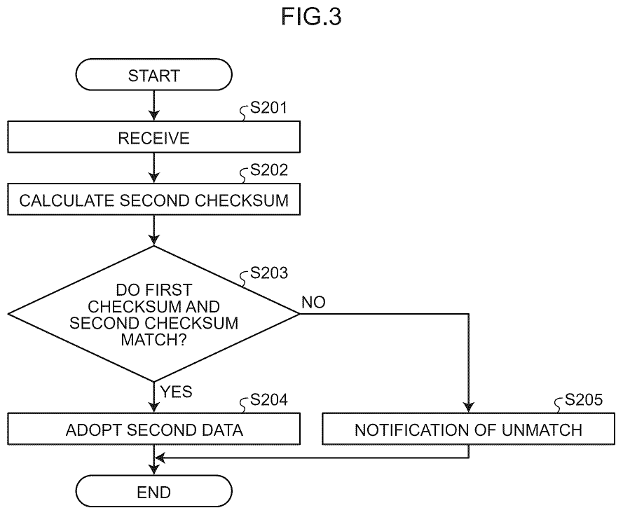

Next, the configuration and operation of the reception device 200 will be described. As illustrated in FIG. 1, the reception device 200 includes a reception unit 210, a checksum calculation unit 220, and a comparison unit 230. FIG. 3 is a flowchart illustrating the operation of the reception device 200 according to the first embodiment.

The reception unit 210 receives the first checksum calculated from the first data and the second data transmitted from the transmission device 100 (step S201). In the first embodiment, the reception unit 210 receives the combined first checksum and second data from the transmission device 100. The reception unit 210 divides the received first checksum and second data, outputs the first checksum to the comparison unit 230, and outputs the second data to the checksum calculation unit 220. Note that the reception unit 210 may output the first checksum and the second data to the checksum calculation unit 220 in a combined state without dividing the first checksum and the second data.

The checksum calculation unit 220 is a second checksum calculation unit that calculates a second checksum by performing a prescribed computation on the second data acquired from the reception unit 210 (step S202). Here, the calculation method for the checksum calculation unit 122 included in the transmission device 100 and the calculation method for the checksum of the checksum calculation unit 220 included in the reception device 200 are the same. That is, in a case where the first data input to the checksum calculation unit 122 of the transmission device 100 and the second data input to the checksum calculation unit 220 of the reception device 200 are the same and both the checksum calculation unit 122 of the transmission device 100 and the checksum calculation unit 220 of the reception device 200 normally perform computation, the calculated first checksum and second checksum have the same value. The checksum calculation unit 220 outputs the calculated second checksum and the second data acquired from the reception unit 210 to the comparison unit 230. In a case where the first checksum is also acquired from the reception unit 210, the checksum calculation unit 220 outputs the first checksum and the second data acquired from the reception unit 210 to the comparison unit 230 together with the calculated second checksum.

The comparison unit 230 compares the first checksum with the second checksum. When the first checksum and the second checksum match (step S203: Yes), the comparison unit 230 adopts the second data (step S204). The comparison unit 230 may output the second data to another configuration (not illustrated) inside the reception device 200 or to the outside of the reception device 200. When the first checksum and the second checksum do not match (step S203: No), the comparison unit 230 notifies the user of the reception device 200 or the like that the first checksum and the second checksum do not match (step S205).

Here, it is assumed that some failure has occurred in the transmission device 100. For example, in a case where the calculation unit 121 of the transmission device 100 has malfunctioned, the calculation unit 121 cannot calculate accurate first data. The checksum calculation unit 122 uses the inaccurate first data even when there is no malfunction, and thus cannot calculate the first checksum for the proper accurate first data. Therefore, the first checksum and the second checksum do not match, and thus the comparison unit 230 of the reception device 200 can determine that some failure has occurred in the transmission device 100. The same applies to a case where the checksum calculation unit 122 of the transmission device 100 has malfunctioned.

In addition, in a case where the calculation unit 131 of the transmission device 100 has malfunctioned, the calculation unit 131 cannot calculate accurate second data. The checksum calculation unit 220 of the reception device 200 uses the inaccurate second data, and thus cannot calculate the second checksum for the proper accurate second data. Therefore, the first checksum and the second checksum do not match, and thus the comparison unit 230 of the reception device 200 can determine that some failure has occurred in the transmission device 100.

Note that, in a case where the combining unit 150 of the transmission device 100 has malfunctioned, the transmission unit 160 can detect that the data is inaccurate by performing a checksum calculation similar to that of the reception device 200. Therefore, the transmission device 100 can determine that some kind of failure has occurred in the received data. Therefore, in a case where the combining unit 150 has malfunctioned, inaccurate data due to the malfunction of the combining unit 150 is not transmitted from the transmission unit 160 of the transmission device 100 to the reception device 200.

As described above, the reception device 200 can easily detect the failure in the duplicated data calculation occurring in the transmission device 100 by using the information received from the transmission device 100. That is, it can also be said that the transmission device 100 can transmit, to the reception device 200, information that can easily detect a failure in the duplicated data calculation occurring in the transmission device 100. As a cause of the mismatch between the first checksum and the second checksum, there may be a case where the checksum calculation unit 220 cannot calculate an accurate second checksum due to a malfunction of the checksum calculation unit 220 of the reception device 200. Therefore, in a case where the first checksum and the second checksum do not match, the comparison unit 230 of the reception device 200 may determine that some kind of failure has occurred in the transmission device 100 or the reception device 200. However, in consideration of the complexity of the operation of each of the transmission device 100 and the reception device 200, the transmission device 100 is considered to have a higher probability of failure than the reception device 200.

Next, hardware configurations of the transmission device 100 according to the first embodiment will be described. In the transmission device 100, the transmission unit 160 is a transmitter capable of transmitting the first checksum and the second data to the reception device 200. The branching unit 110, the computers 120 and 130, and the combining unit 150 are implemented by processing circuitry. The processing circuitry may be a memory storing a program and a processor that executes a program stored in the memory, or may be dedicated hardware. The processing circuitry is also called a control circuit.

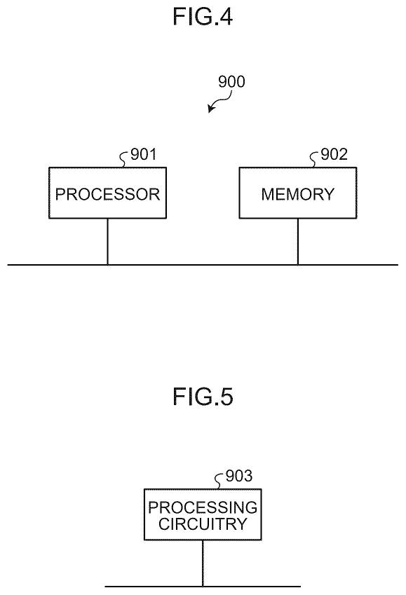

FIG. 4 is a diagram illustrating an exemplary configuration of processing circuitry 900 in the case that the processing circuitry provided in the transmission device 100 according to the first embodiment is implemented by a processor 901 and a memory 902. The processing circuitry 900 illustrated in FIG. 4 is a control circuit and includes the processor 901 and the memory 902. In a case where the processing circuitry 900 is configured with the processor 901 and the memory 902, each function of the processing circuitry 900 is implemented by software, firmware, or a combination of software and firmware. Software or firmware is described as a program and stored in the memory 902. In the processing circuitry 900, the processor 901 reads and executes the program stored in the memory 902, thereby implementing each function. That is, the processing circuitry 900 includes the memory 902 for storing the programs that result in the processing of the transmission device 100. It can also be said that this program is a program for causing the transmission device 100 to execute each function implemented by the processing circuitry 900. This program may be provided by a storage medium in which the program is stored, or may be provided by other means such as a communication medium.

The program can also be said to be a program that causes the transmission device 100 to execute: a first calculation step in which the calculation unit 121 of the computer 120 calculates first data by performing a calculation on an input signal; a first checksum calculation step in which the checksum calculation unit 122 of the computer 120 calculates a first checksum by performing a calculation on the first data; a second calculation step in which the calculation unit 131 of the computer 130 calculates second data by performing a calculation on an input signal; and a transmission step in which the transmission unit 160 transmits the first checksum and the second data to the reception device 200.

The processor 901 is exemplified by a central processing unit (CPU), a processing device, an arithmetic device, a microprocessor, a microcomputer, or a digital signal processor (DSP). Examples of the memory 902 include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

FIG. 5 is a diagram illustrating an example of processing circuitry 903 in the case that the processing circuitry of the transmission device 100 according to the first embodiment is implemented by dedicated hardware. For example, the processing circuitry 903 illustrated in FIG. 5 is a single circuit, a composite circuit, a programmed processor, a parallel programmed processor, an application specific integrated circuit (ASIC), a field programmable gate array (FPGA), or a combination thereof. A part of the processing circuitry 903 may be implemented by dedicated hardware, and the other part may be implemented by software or firmware. In this manner, the processing circuitry 903 can implement each of the above-described functions by means of dedicated hardware, software, firmware, or a combination thereof.

Although the hardware configurations of the transmission device 100 have been described, the hardware configurations of the reception device 200 are similar. In the reception device 200, the reception unit 210 is a receiver capable of receiving the first checksum and the second data from the transmission device 100. The checksum calculation unit 220 and the comparison unit 230 are implemented by processing circuitry. The processing circuitry may be a memory storing a program and a processor that executes a program stored in the memory, or may be dedicated hardware.

As described above, according to the present embodiment, in the communication system 300, the transmission device 100 uses the same input signal for the computer 120 to calculate the first data and calculate the first checksum for the first data, and for the computer 130 to calculate the second data, combines the first checksum and the second data, and transmits the combined data to the reception device 200. The reception device 200 calculates a second checksum for the second data, and adopts the second data when the first checksum and the second checksum match. When the first checksum and the second checksum do not match, the reception device 200 can determine that some failure has occurred in the transmission device 100. In other words, the transmission device 100 can transmit, to the reception device 200, information that can easily detect a failure in the duplicated data calculation occurring in the transmission device 100.

### Second Embodiment

In the first embodiment, the transmission device 100 combines the first checksum and the second data and transmits the combined data to the reception device 200. In the second embodiment, a case where the transmission device transmits the first checksum and the second data to the reception device 200 without combining will be described.

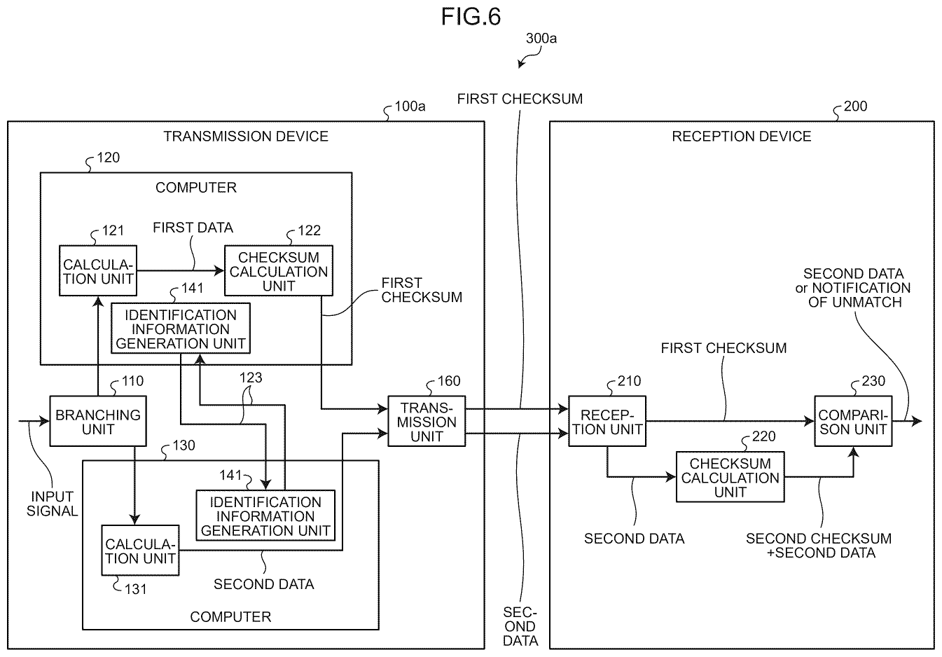

FIG. 6 is a diagram illustrating an exemplary configuration of a communication system 300a according to the second embodiment. The communication system 300a includes a transmission device 100a and the reception device 200. The application of the communication system 300a is similar to that of the communication system 300 of the first embodiment.

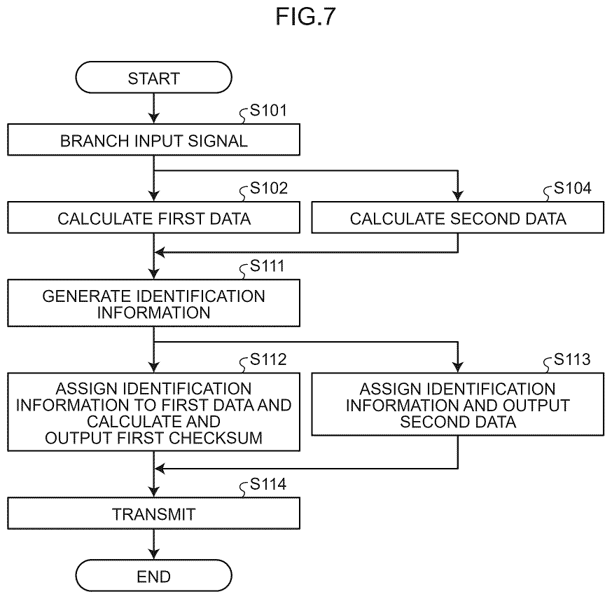

First, the configuration and operation of the transmission device 100a will be described. As illustrated in FIG. 6, the transmission device 100a is obtained by adding an identification information generation unit 141 in each of the computers 120 and 130 to the transmission device 100 of the first embodiment illustrated in FIG. 1. The identification information generation unit 141 of the computer 120 is a first identification information generation unit that generates identification information for the first data. The identification information generation unit 141 of the computer 130 is a second identification information generation unit that generates identification information for the second data. FIG. 7 is a flowchart illustrating the operation of the transmission device 100a according to the second embodiment. In the flowchart illustrated in FIG. 7, the operations of steps S101, S102, and S104 are the same as the operations of steps S101, S102, and S104 of the flowchart of the first embodiment illustrated in FIG. 2.

The identification information generation unit 141 of the computers 120 and 130 generates identification information for the first data and the second data based on the same input signal (step S111). Here, the identification information is generated, for example, by each identification information generation unit 141 of each of the computers 120 and 130 incrementing the integer by one for each input signal. In a case where the identification information is generated with this method, the computers 120 and 130 do not need timing adjustment by the timing adjustment interface 123. Alternatively, each of the computers 120 and 130 can also generate the identification information by outputting an integer generated by the computer to the other computer in the timing message and adding a value generated by the computer and a value transmitted from the other computer. Here, each of the computers 120 and 130 may generate the “integer generated by the computer” by incrementing the value by one, or by generating a random value. Furthermore, the method of combining the integer generated by the computer and the integer generated by the counterpart does not need to be limited to addition, and may be either addition, subtraction, multiplication, or division, or may be another calculation formula that is based on a specific rule. The identification information generation unit 141 of the computer 120 generates the same identification information as the identification information generated by the identification information generation unit 141 of the computer 130 and outputs the same to the checksum calculation unit 122 of the computer 120. The identification information generation unit 141 of the computer 130 generates the same identification information as the identification information generated by the identification information generation unit 141 of the computer 120 and outputs the same to the calculation unit 131 of the computer 130. Although not illustrated in FIG. 6, the identification information generation unit 141 of the computers 120 and 130 may generate the identification information after acquiring the information obtained by branching the input signal from the branching unit 110, and output the identification information to the checksum calculation unit 122 of the computer 120 and the calculation unit 131 of the computer 130. As described above, the identification information generation unit 141 of the computer 120 and the identification information generation unit 141 of the computer 130 generate the identification information with a prescribed generation method such that the same identification information is generated for the first data and the second data based on the same input signal.

The checksum calculation unit 122 of the computer 120 calculates a first checksum by assigning the identification information acquired from the identification information generation unit 141 to the first data calculated by the calculation unit 121, and outputs the first checksum to the transmission unit 160 (step S112). In addition, the calculation unit 131 of the computer 130 assigns the identification information acquired from the identification information generation unit 141 to the calculated second data, and outputs the second data to the transmission unit 160 (step S113).

The transmission unit 160 transmits the first checksum calculated from the first data assigned with the identification information, acquired from the checksum calculation unit 122 of the computer 120, to the reception device 200. In addition, the transmission unit 160 transmits the second data assigned with the identification information, acquired from the calculation unit 131 of the computer 130, to the reception device 200 (step S114). The transmission unit 160 may transmit the first checksum to the reception device 200 and transmit the second data to the reception device 200 at the same timing or different timings.

In the first embodiment, the transmission device 100 combines the first checksum and the second data based on the same input signal and transmits the combined data to the reception device 200, thereby causing the reception device 200 to grasp the combination of the first checksum and the second data based on the same input signal. On the other hand, in the second embodiment, the transmission device 100a transmits, to the reception device 200, the first checksum calculated by assigning the identification information to the first data based on the same input signal and the second data assigned with the identification information, so as to allow the reception device 200 to grasp the combination of the first checksum and the second data based on the same input signal.

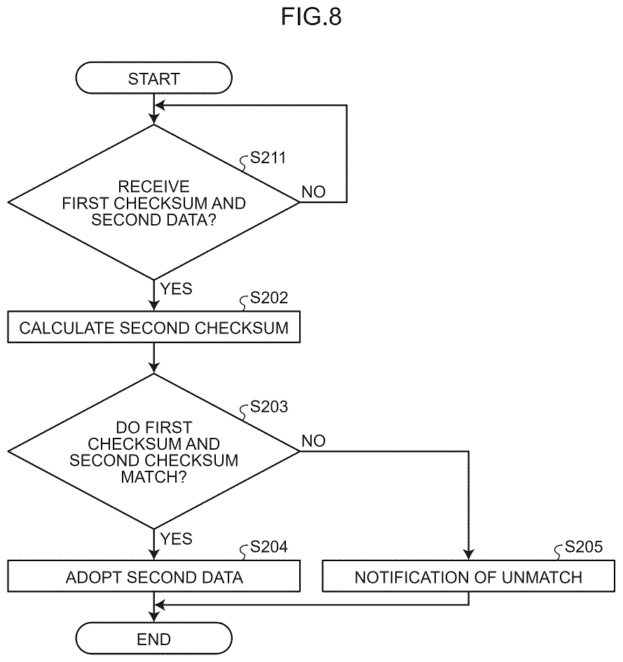

Next, the configuration and operation of the reception device 200 will be described. As illustrated in FIG. 6, the configuration of the reception device 200 is the same as the configuration of the reception device 200 of the first embodiment illustrated in FIG. 1. FIG. 8 is a flowchart illustrating the operation of the reception device 200 according to the second embodiment.

In a case where the first checksum and the second data have not been received from the transmission device 100a (step S211: No), the reception unit 210 waits until the first checksum and the second data are received. When receiving the first checksum and the second data from the transmission device 100a (step S211: Yes), the reception unit 210 outputs the first checksum to the comparison unit 230 and outputs the second data to the checksum calculation unit 220.

The checksum calculation unit 220 calculates a second checksum by performing a prescribed computation on the second data acquired from the reception unit 210 (step S202). At this time, since the identification information is assigned to the second data, the checksum calculation unit 220 calculates the second checksum by performing calculation on the second data assigned with the identification information. In the second embodiment, the calculation method of the checksum calculation unit 220 is the same as the calculation method of the checksum calculation unit 122 of the transmission device 100a of the second embodiment. The checksum calculation unit 220 outputs the calculated second checksum and the second data acquired from the reception unit 210 to the comparison unit 230. In a case where the first checksum is also acquired from the reception unit 210, the checksum calculation unit 220 outputs the first checksum and the second data acquired from the reception unit 210 to the comparison unit 230 together with the calculated second checksum.

The comparison unit 230 compares the second checksum with the first checksum calculated from the first data assigned with the same identification information as the identification information assigned to the second data. When the first checksum and the second checksum match (step S203: Yes), the comparison unit 230 adopts the second data (step S204). In the second embodiment, the first checksum is calculated by including the identification information in the first data, and the second checksum is calculated by including the identification information in the second data. The first data and the second data are calculated from the same input signal, and the identification information is the same. Therefore, in a case where the first checksum and the second checksum match, it means that all the calculations have been normally performed in the transmission device 100a and the checksum calculation unit 220. The comparison unit 230 may delete the assigned identification information from the second data, and output the second data to another configuration (not illustrated) inside the reception device 200 or to the outside of the reception device 200. When the first checksum and the second checksum do not match (step S203: No), the comparison unit 230 notifies the user of the reception device 200 or the like that the first checksum and the second checksum do not match (step S205).

Hardware configurations of the optical transmission device 100a will be described. In the transmission device 100a, the identification information generation unit 141 is implemented by processing circuitry. The processing circuitry may be a memory storing a program and a processor that executes a program stored in the memory, or may be dedicated hardware.

As described above, according to the present embodiment, in the communication system 300a, the transmission device 100a separately transmits, to the reception device 200, the first checksum calculated from the first data assigned with the identification information and the second data assigned with the same identification information as the identification information assigned to the first data. Also in this case, the communication system 300a can obtain effects similar to those in the first embodiment.

### Third Embodiment

In the first embodiment, the transmission device 100 transmits the first checksum and the second data based on a certain input signal to the reception device 200 once. In the third embodiment, a case where the transmission device transmits the first checksum and the second data based on a certain input signal to the reception device 200 a plurality of times, that is, continuously transmits the first checksum and the second data, will be described.

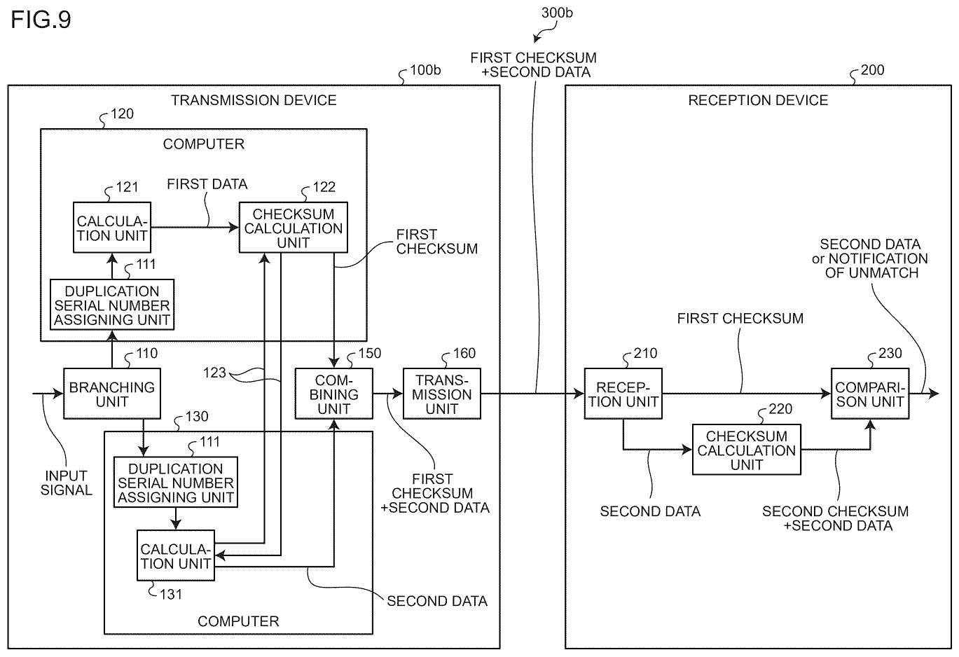

FIG. 9 is a diagram illustrating an exemplary configuration of a communication system 300b according to the third embodiment. The communication system 300b includes a transmission device 100b and the reception device 200. The application of the communication system 300b is similar to that of the communication system 300 of the first embodiment.

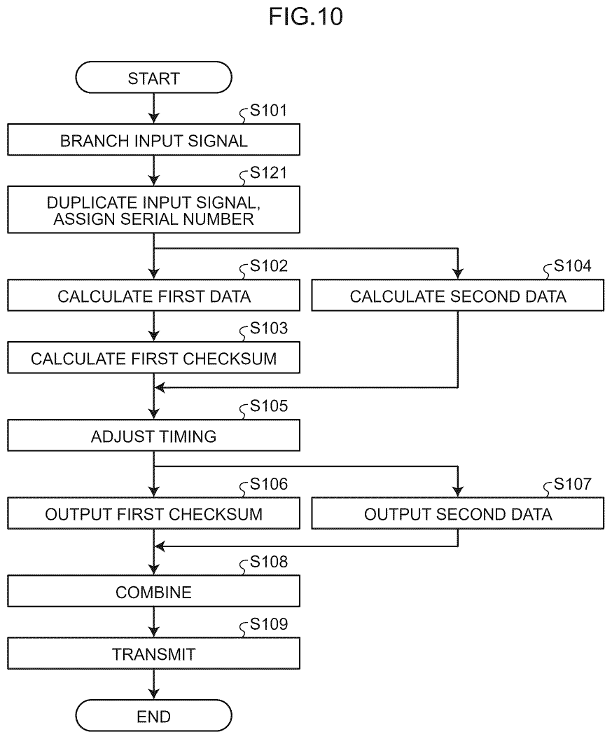

First, the configuration and operation of the transmission device 100b will be described. As illustrated in FIG. 9, the transmission device 100b is obtained by adding a duplication serial number assigning unit 111 in each of the computers 120 and 130 to the transmission device 100 of the first embodiment illustrated in FIG. 1. The duplication serial number assigning unit 111 of the computer 120 is a first duplication serial number assigning unit that duplicates the input signal, assigns serial numbers to the input signals obtained by duplicating the input signal, and outputs the input signals to the calculation unit 121. The duplication serial number assigning unit 111 of the computer 130 is a second duplication serial number assigning unit that duplicates the input signal, assigns serial numbers to the input signals obtained by duplicating the input signal, and outputs the input signals to the calculation unit 131. FIG. 10 is a flowchart illustrating the operation of the transmission device 100b according to the third embodiment.

After the operation in step S101, the duplication serial number assigning unit 111 of each of the computers 120 and 130 duplicates the input signal acquired from the branching unit 110, and assigns serial numbers to the obtained input signals (step S121). The duplication serial number assigning unit 111 duplicates the input signal by the number of times the transmission device 100b transmits the first checksum and the second data to the reception device 200. For example, in a case where the transmission device 100b transmits the first checksum and the second data to the reception device 200 five times, the duplication serial number assigning unit 111 duplicates the input signal for five transmissions, and assigns sequence numbers to the input signals. The serial numbers for the five transmissions are, for example, 1, 2, 3, 4, 5, and the like. The duplication serial number assigning unit 111 of the computer 120 outputs, to the calculation unit 121, the input signal assigned with the serial number 1, the input signal assigned with the serial number 2, the input signal assigned with the serial number 3, the input signal assigned with the serial number 4, and the input signal assigned with the serial number 5. Similarly, the duplication serial number assigning unit 111 of the computer 130 outputs, to the calculation unit 131, the input signal assigned with the serial number 1, the input signal assigned with the serial number 2, the input signal assigned with the serial number 3, the input signal assigned with the serial number 4, and the input signal assigned with the serial number 5.

In the computer 120, the calculation unit 121 calculates first data by performing a prescribed calculation on each of duplicated input signals having different serial numbers (step S102), and outputs the first data to the checksum calculation unit 122. Here, in the above-described example, the calculation unit 121 calculates the first data by performing calculation on the five input signals assigned with different serial numbers, which are the same input signals, with the calculation including the serial numbers. Therefore, the five pieces of first data calculated by the calculation unit 121 for the five input signals all have different values.

The checksum calculation unit 122 calculates a first checksum by performing calculation on each of the plurality of pieces of first data (step S103). In the above example, since the five pieces of first data all have different values, the five first checksums calculated by the checksum calculation unit 122 for the five pieces of first data all have different values.

In the computer 130, the calculation unit 131 calculates second data by performing calculation on each of duplicated input signals having different serial numbers (step S104). Here, in the above-described example, the calculation unit 131 calculates the second data by performing calculation on the five input signals assigned with different serial numbers, which are the same input signals, with the calculation including the serial numbers. Therefore, the five pieces of second data calculated by the calculation unit 131 for the five input signals all have different values. In the flowchart illustrated in FIG. 10, the subsequent operations from step S105 to step S109 are the same as the operations from step S105 to step S109 in the flowchart of the first embodiment illustrated in FIG. 2, although the amount of operation of the transmission device 100b increases as the input signal is duplicated.

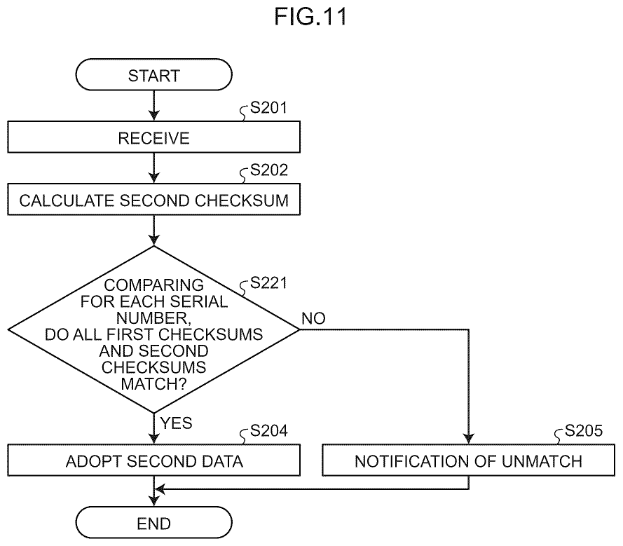

Next, the configuration and operation of the reception device 200 will be described. As illustrated in FIG. 9, the configuration of the reception device 200 is the same as the configuration of the reception device 200 of the first embodiment illustrated in FIG. 1. FIG. 11 is a flowchart illustrating the operation of the reception device 200 according to the third embodiment.

The reception unit 210 receives the first checksum and the second data transmitted from the transmission device 100b (step S201). The reception unit 210 receives the first checksum and the second data based on the same input signal five times in the above example, but each operation is the same as the operation in the first embodiment.

In a case where the input signal is duplicated in the transmission device 100b, different serial numbers are assigned to the input signals, the first checksum is calculated for each of the duplicated input signals having different serial numbers by the computer 120, and the second data is calculated for each of the duplicated input signals having different serial numbers by the computer 130, the checksum calculation unit 220 calculates a second checksum by performing calculation on all the second data based on the same input signal (step S202). In the above example, since the five pieces of second data all have different values, the five second checksums calculated by the checksum calculation unit 220 for the five pieces of first data all have different values.

The comparison unit 230 compares the first checksum and the second checksum for each serial number. When the first checksum and the second checksum all match (step S221: Yes), the comparison unit 230 adopts the second data (step S204). Since five combinations of first checksums and second checksums are obtained in the above example, the comparison unit 230 compares the first checksums and the second checksums based on the same input signal five times, and adopts the second data when the first checksums and the second checksums match in all five times. Note that, in the third embodiment, since the transmission device 100b combines and transmits the first checksum and the second data, each configuration of the reception device 200 can regard the first checksum and the second data received in a combined state as being based on input signals of the same serial number. The comparison unit 230 compares the first checksum and the second checksum for each serial number, and in a case where there is at least one combination in which the first checksum and the second checksum do not match (step S221: No), notifies the user of the reception device 200 or the like that the first checksum and the second checksum do not match (step S205).

Hardware configurations of the optical transmission device 100b will be described. In the transmission device 100b, the duplication serial number assigning unit 111 is implemented by processing circuitry. The processing circuitry may be a memory storing a program and a processor that executes a program stored in the memory, or may be dedicated hardware.

As described above, according to the present embodiment, in the communication system 300b, the transmission device 100b duplicates one input signal and assigns serial numbers to the input signals, and performs the same operation as that of the transmission device 100 of the first embodiment on the input signals assigned with different serial numbers. The reception device 200 compares the first checksum and the second checksum for each serial number, and in a case where all the checksums match, adopts the second data. In a case where there is at least one combination in which the first checksum and the second checksum do not match, the reception device 200 can determine that some failure has occurred in the transmission device 100b. In other words, the transmission device 100b can transmit, to the reception device 200, information that can easily detect a failure in the duplicated data calculation occurring in the transmission device 100b. In the third embodiment, the communication system 300b can improve the accuracy of the reception device 200 detecting the failure of the transmission device 100b more than the accuracy of the reception device 200 detecting the failure of the transmission device 100 in the first embodiment.

In the third embodiment, specifically, the case where the transmission device 100b continuously transmits the first checksum and the second data five times has been described, but the number of continuous transmissions of the transmission device 100b is not limited thereto. The communication system 300b can appropriately increase or decrease the number of continuous transmissions of the transmission device 100b according to the number of bits of the first data and the second data, the degree of detection of error, and the like. The same applies to the fourth embodiment described later.

### Fourth Embodiment

In the third embodiment, the case where the transmission device 100b transmits the first checksum and the second data based on a certain input signal to the reception device 200 a plurality of times, that is, continuously transmits the first checksum and the second data, has been described using the first embodiment as an example. In the fourth embodiment, a case where the transmission device transmits the first checksum and the second data based on a certain input signal to the reception device 200 a plurality of times, that is, continuously transmits the first checksum and the second data, will be described using the second embodiment as an example.

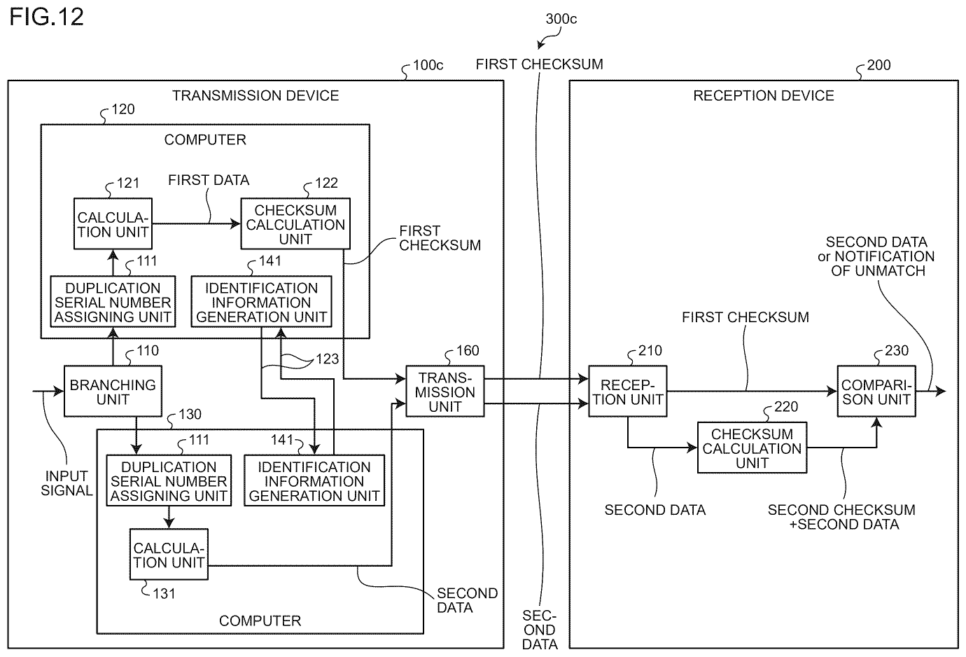

FIG. 12 is a diagram illustrating an exemplary configuration of a communication system 300c according to the fourth embodiment. The communication system 300c includes a transmission device 100c and the reception device 200. The application of the communication system 300c is similar to that of the communication system 300 of the first embodiment.

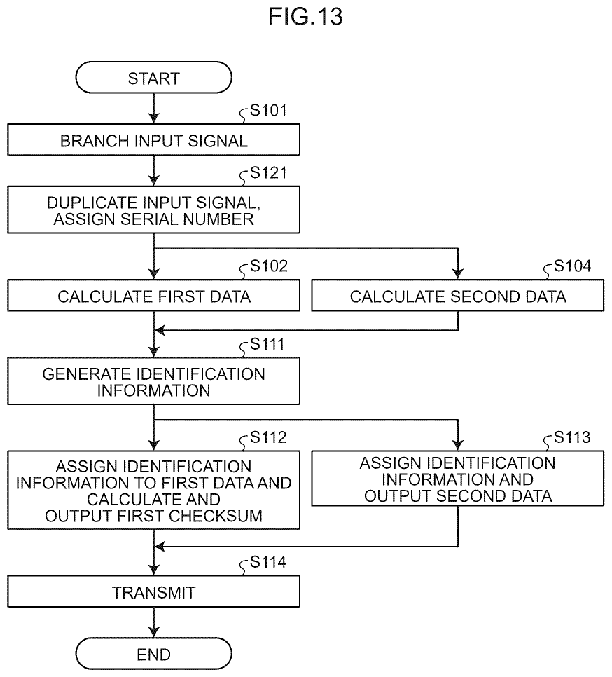

First, the configuration and operation of the transmission device 100c will be described. As illustrated in FIG. 12, the transmission device 100c is obtained by adding the duplication serial number assigning unit 111 in each of the computers 120 and 130 to the transmission device 100a of the second embodiment illustrated in FIG. 6. FIG. 13 is a flowchart illustrating the operation of the transmission device 100c according to the fourth embodiment. The flowchart of the fourth embodiment illustrated in FIG. 13 is different from the flowchart of the second embodiment illustrated in FIG. 7 in the operation of step S121, but the operation of step S121 is the same as the operation of step S121 of the flowchart of the third embodiment illustrated in FIG. 10. Therefore, detailed description is omitted.

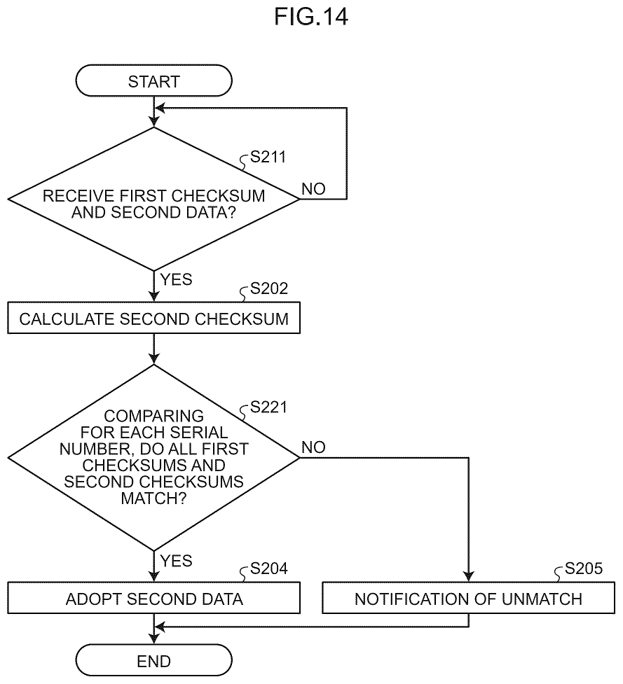

Next, the configuration and operation of the reception device 200 will be described. As illustrated in FIG. 12, the configuration of the reception device 200 is the same as the configuration of the reception device 200 of the second embodiment illustrated in FIG. 6. FIG. 14 is a flowchart illustrating the operation of the reception device 200 according to the fourth embodiment. The flowchart of the fourth embodiment illustrated in FIG. 14 is different from the flowchart of the second embodiment illustrated in FIG. 8 in the operation of step S221, but the operation of step S221 is the same as the operation of step S221 of the flowchart of the third embodiment illustrated in FIG. 11. Therefore, detailed description is omitted. In the fourth embodiment, the first checksum is calculated by including the identification information in the first data based on the input signal assigned with the serial number, and the second checksum is calculated by including the identification information in the second data based on the input signal assigned with the serial number. The first data and the second data are calculated from the same input signal assigned with the same serial number, and the identification information is the same. Therefore, in a case where the first checksum and the second checksum all match, it means that all the calculations have been normally performed in the transmission device 100c and the checksum calculation unit 220.

As described above, according to the present embodiment, in the communication system 300c, the transmission device 100c duplicates one input signal and assigns serial numbers to the input signals, and performs the same operation as that of the transmission device 100a of the second embodiment on the input signals assigned with different serial numbers, that is, separately transmits, to the reception device 200, the first checksum calculated from the first data assigned with the identification information and the second data assigned with the same identification information as the identification information assigned to the first data. Also in this case, the communication system 300c can obtain effects similar to those in the third embodiment.

### Fifth Embodiment

In the first to fourth embodiments, in order to detect a failure in the duplicated data calculation, each transmission device includes one computer 120 that is the first computer for the computer 130 that is the second computer. In the fifth embodiment, a case where the transmission device further includes a plurality of computers 120 as the first computers, that is, the transmission device multiplexes the computers 120 as the first computers, will be described.

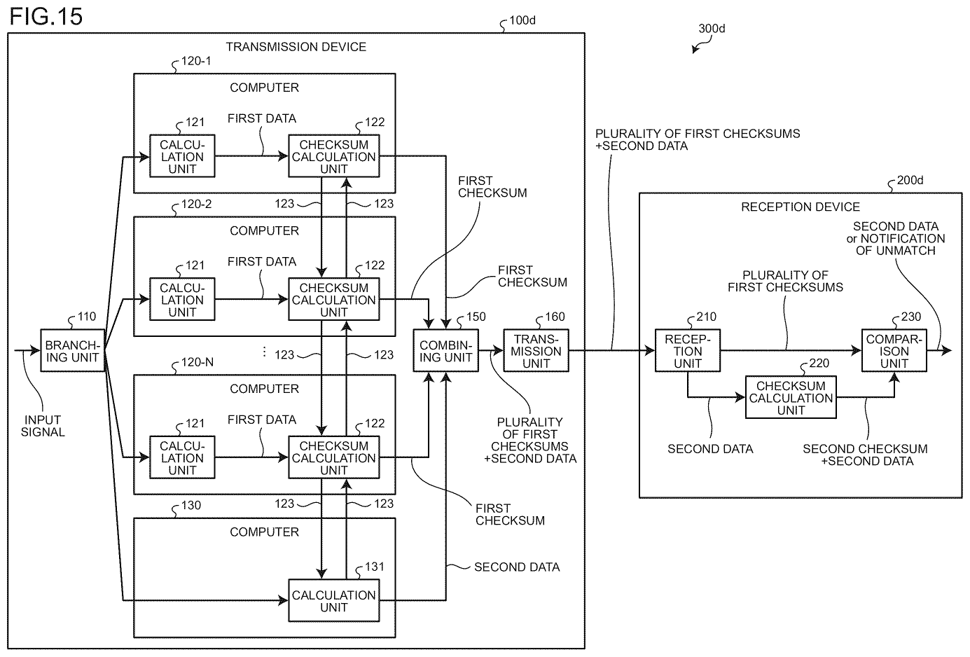

FIG. 15 is a diagram illustrating an exemplary configuration of a communication system 300d according to the fifth embodiment in which the first computers included in the transmission device 100 of the first embodiment are configured in a redundant manner. The communication system 300d includes a transmission device 100d and a reception device 200d. The application of the communication system 300d is similar to that of the communication system 300 of the first embodiment. The transmission device 100d assumes a case where the transmission device 100 of the first embodiment illustrated in FIG. 1 includes a plurality of computers 120: a plurality of computers 120-1 to 120-N which are N computers 120 in the example of FIG. 15. Note that N is an integer of two or more. When the computers 120-1 to 120-N are not distinguished, they are simply referred to as the computers 120. Hereinafter, the operation of the communication system 300d will be described focusing on the difference from the operation of the communication system 300 of the first embodiment.

In the transmission device 100d, the branching unit 110 branches the input signal into N+1, and outputs the respective input signals to the computers 120-1 to 120-N and the computer 130.

In the computers 120-1 to 120-N, each calculation unit 121 calculates first data by performing a prescribed similar calculation on the input signal, and outputs the first data to the checksum calculation unit 122. In the computers 120-1 to 120-N, each checksum calculation unit 122 calculates a first checksum by performing a prescribed similar calculation on the first data, and outputs the first checksum to the combining unit 150. In the present embodiment, each calculation unit 121 and each checksum calculation unit 122 of the computers 120-1 to 120-N perform similar calculation. Therefore, when the calculation is normally performed in each calculation unit 121 and each checksum calculation unit 122 of the computers 120-1 to 120-N, all the first checksums output from the computers 120-1 to 120-N have the same value.

Each of the checksum calculation units 122 of the computers 120-1 to 120-N and the calculation unit 131 of the computer 130 adjust the timing at which each of the checksum calculation units 122 of the computers 120-1 to 120-N outputs the first checksum to the combining unit 150 and the timing at which the calculation unit 131 of the computer 130 outputs the second data to the combining unit 150 using the timing message via the timing adjustment interface 123. Each checksum calculation unit 122 of the computers 120-1 to 120-N outputs the first checksum to the combining unit 150 according to the adjusted timing. In addition, the calculation unit 131 of the computer 130 outputs the second data to the combining unit 150 according to the adjusted timing.

The combining unit 150 combines the N first checksums output from the respective checksum calculation units 122 of the computers 120-1 to 120-N and one piece of second data output from the calculation unit 131 of the computer 130. The combining unit 150 outputs the combined N first checksums and the one piece of second data to the transmission unit 160. The combining unit 150 combines the N first checksums and the one piece of second data, assuming that the N first checksums arriving from the respective checksum calculation units 122 of the computers 120-1 to 120-N and the one piece of second data arriving from the calculation unit 131 of the computer 130 within the same or a prescribed range of time difference are based on the same input signal. In a case where the N first checksums and the one piece of second data cannot be acquired within the prescribed range of time difference, the combining unit 150 may notify the user of the transmission device 100d or the like of the fact.

The transmission unit 160 transmits the N first checksums and the one piece of second data to the reception device 200d. For example, in a case where the first data and the second data calculated by each calculation unit 121 of the computers 120-1 to 120-N and the calculation unit 131 of the computer 130 are [0xc0 0xA8 0xFF 0x58], and the first checksum calculated by each checksum calculation unit 122 of the computers 120-1 to 120-N is [0xBF], the combined N first checksums and one piece of second data transmitted from the transmission unit 160 are [0xBF 0xBF . . . 0xBF 0xc0 0xA8 0xFF 0x58].

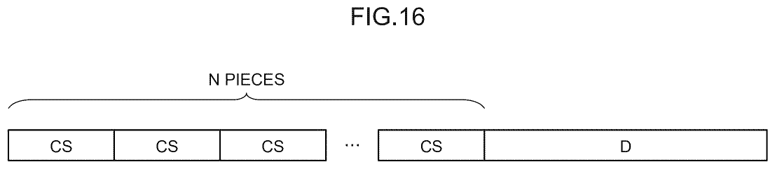

FIG. 16 is a diagram illustrating an example of a data frame including N first checksums and one piece of second data transmitted from the transmission device 100d of the communication system 300d to the reception device 200d according to the fifth embodiment. In FIG. 16, the first checksum is represented by CS and the second data is represented by D. Note that, here, the order of the combined N first checksums and one piece of second data is the N first checksums and the one piece of second data, but the order may be the one piece of second data and the N first checksums as long as the order is known between the transmission device 100d and the reception device 200d.

In the reception device 200d, the reception unit 210 receives the N first checksums and the one piece of second data transmitted from the transmission device 100d. The reception unit 210 divides the received N first checksums and one piece of second data, outputs the N, that is, the plurality of first checksums, to the comparison unit 230, and outputs the one piece of second data to the checksum calculation unit 220. The operation of the checksum calculation unit 220 is the same as the operation of the checksum calculation unit 220 of the first embodiment.

The comparison unit 230 compares the N, that is, the plurality of first checksums, with the one second checksum. In a case where all of the N first checksums and the one second checksum match, the comparison unit 230 adopts the second data. In a case where at least one of the N first checksums and the one second checksum does not match, the comparison unit 230 notifies the user of the reception device 200d or the like that the N first checksums and the one second checksum do not match.

Here, suppose that some failure has occurred in a part of the components in the communication system 300d. For example, in a case where one or more of the computers 120-1 to 120-N included in the transmission device 100d has malfunctioned, the malfunctioning computer 120 outputs a first checksum different from that of the non-malfunctioning computer 120. In this case, since the comparison unit 230 of the reception device 200d determines that the N first checksums do not match the one second checksum, the second data is not adopted.

In addition, in a case where the computer 130 included in the transmission device 100d has malfunctioned, one second checksum calculated by the checksum calculation unit 220 of the reception device 200d has a value different from the N first checksums calculated by the computers 120-1 to 120-N of the transmission device 100d. Also in this case, since the comparison unit 230 of the reception device 200d determines that the N first checksums do not match the one second checksum, the second data is not adopted.

In addition, when the combining unit 150 of the transmission device 100d has malfunctioned, the N first checksums and the one piece of second data are not correctly combined, and thus the reception device 200d cannot receive the data frame as illustrated in FIG. 16. Also in this case, the second data is not adopted in the reception device 200d.

In addition, in a case where the reception device 200d has malfunctioned, the N first checksums cannot be compared with the one second checksum, and thus the second data is not adopted.

As described above, the communication system 300d can prevent output of an erroneous calculation result when a failure occurs in any component.

Note that, in the reception device 200d, the comparison unit 230 may adopt the second data in a case where the N first checksums match the one second checksum at a prescribed ratio or more in comparison between the N first checksums and the one second checksum. That is, the comparison unit 230 may compare the N first checksums with one second checksum, and determine whether to adopt the second data according to the matching ratio. As a result, even when a malfunction occurs in some of the computers 120-1 to 120-N of the transmission device 100d, the communication system 300d can take measures such as repair and replacement of the malfunctioning computer 120 among the computers 120-1 to 120-N included in the transmission device 100d while operating the transmission device 100d while adopting the second data in the reception device 200d if the number of the malfunctioning computers 120 is small.

As described above, in the present embodiment, in the transmission device 100d, the calculation units 121, which are the first calculation units included in the computers 120-1 to 120-N, which are the plurality of first computers, calculate the first data with the same calculation method. The checksum calculation units 122, which are the first checksum calculation units included in the computers 120-1 to 120-N, which are the plurality of first computers, calculate the first checksum with the same calculation method. The transmission unit 160 transmits, to the reception device 200d, the plurality of first checksums calculated by the checksum calculation units 122, which are the plurality of first checksum calculation units, and the one piece of second data calculated by the calculation unit 131 of the computer 130, which is the second computer.

In addition, in the reception device 200d, the reception unit 210 receives the plurality of first checksums calculated with the same calculation method in the checksum calculation units 122, which are the plurality of first checksum calculation units included in the transmission device 100d, and the one piece of second data calculated by the calculation unit 131 of the computer 130, which is the second computer. The checksum calculation unit 220, which is the second checksum calculation unit, computes one second checksum for the second data with the same computation method as the calculation method performed by the checksum calculation units 122, which are the plurality of first checksum calculation units included in the transmission device 100d. The comparison unit 230 compares the plurality of first checksums with the one second checksum, and determines whether to adopt the second data according to the matching ratio.

As described above, according to the present embodiment, in the communication system 300d, the transmission device 100d includes the plurality of computers 120-1 to 120-N, and the plurality of computers 120-1 to 120-N calculate the first checksum with the same calculation method and output the plurality of first checksums and one piece of second data. The reception device 200d calculates one second checksum using the second data with the same calculation method as the calculation method in the transmission device 100d, compares the plurality of first checksums with the one second checksum, and determines whether to adopt the second data. As a result, the communication system 300d can improve the detection accuracy of the failure in the data calculation as compared with the communication system 300 of the first embodiment by making the computer 120 redundant.

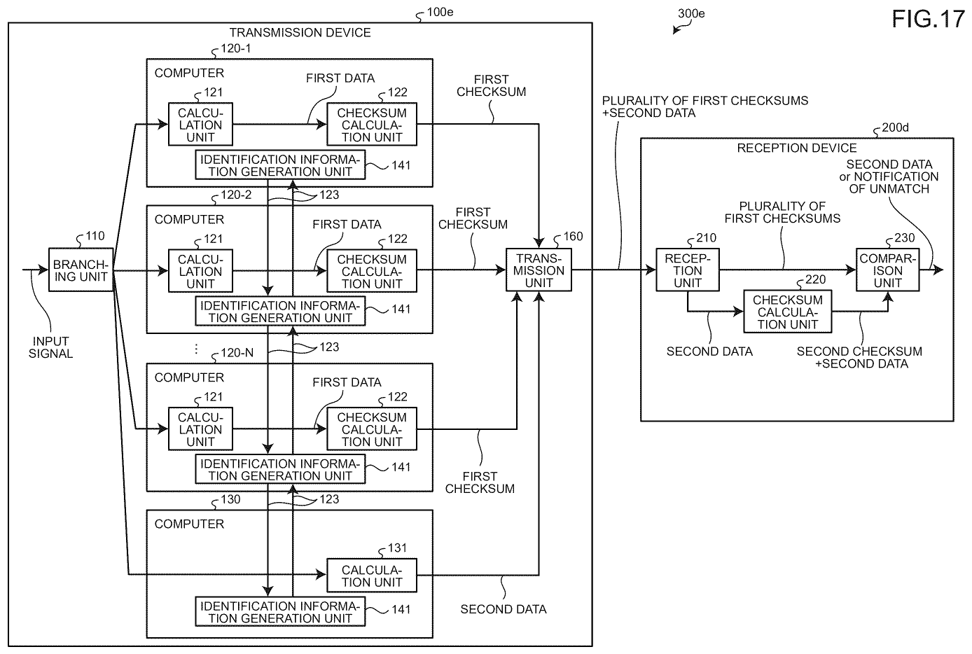

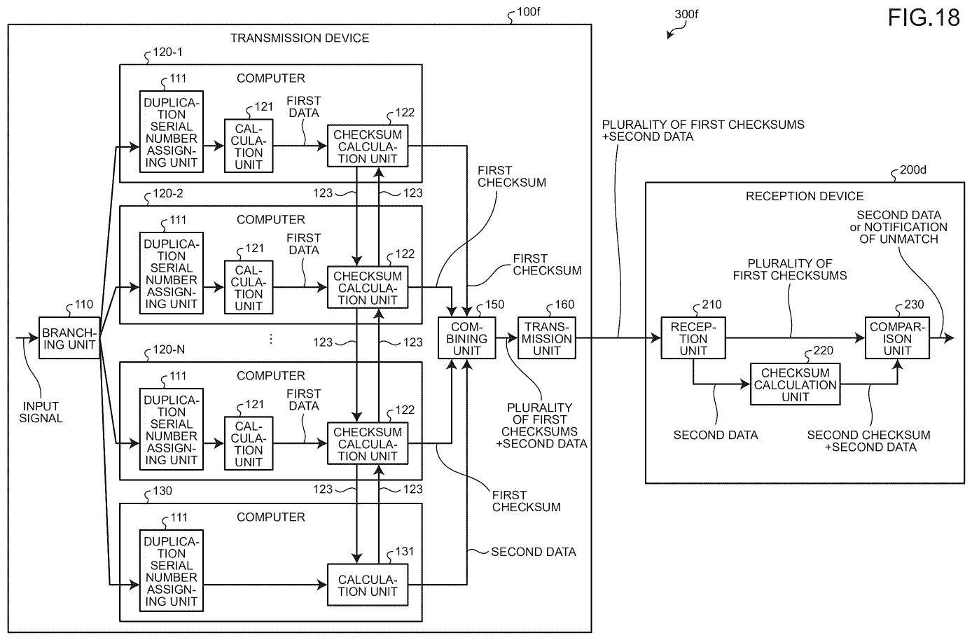

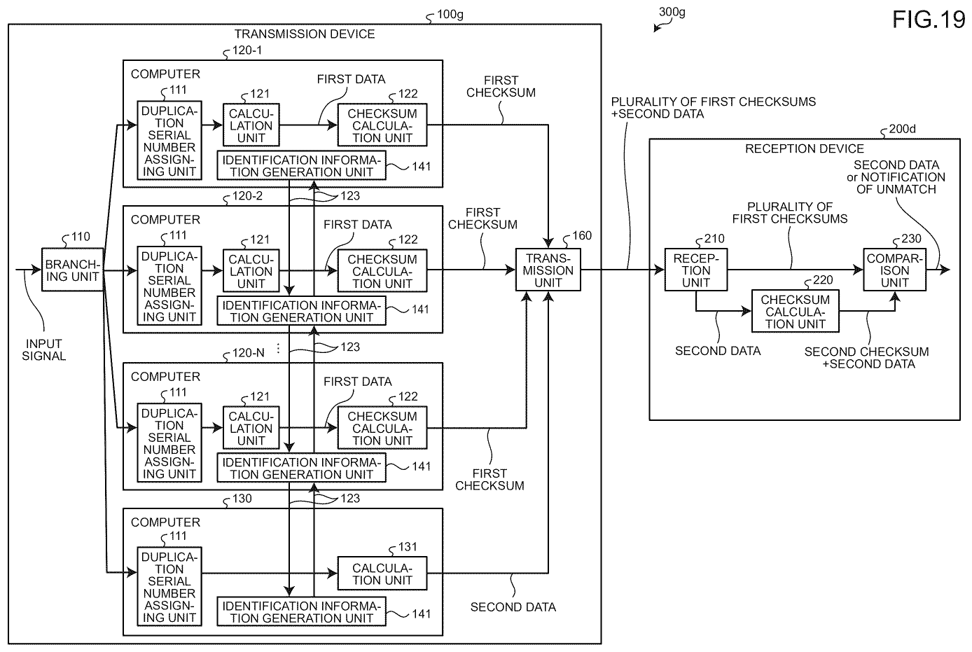

Although the case of the first embodiment has been described as an example, the present embodiment is also applicable to the second to fourth embodiments. FIG. 17 is a diagram illustrating an exemplary configuration of a communication system 300e according to the fifth embodiment in which the first computers included in the transmission device 100a of the second embodiment are configured in a redundant manner. The communication system 300e includes a transmission device 100e and the reception device 200d. In the communication system 300e illustrated in FIG. 17, the transmission device 100e has a redundant configuration of the computer 120 of the transmission device 100a of the communication system 300a illustrated in FIG. 6. FIG. 18 is a diagram illustrating an exemplary configuration of a communication system 300f according to the fifth embodiment in which the first computers included in the transmission device 100b of the third embodiment are configured in a redundant manner. The communication system 300f includes a transmission device 100f and the reception device 200d. In the communication system 300f illustrated in FIG. 18, the transmission device 100f has a redundant configuration of the computer 120 of the transmission device 100b of the communication system 300b illustrated in FIG. 9. FIG. 19 is a diagram illustrating an exemplary configuration of a communication system 300g according to the fifth embodiment in which the first computers included in the transmission device 100c of the fourth embodiment are configured in a redundant manner. The communication system 300g includes a transmission device 100g and the reception device 200d. In the communication system 300g illustrated in FIG. 19, the transmission device 100g has a redundant configuration of the computer 120 of the transmission device 100c of the communication system 300c illustrated in FIG. 12. Although detailed description is omitted, the difference in operation from the original embodiment is substantially the same as the difference between the operation of the present embodiment described in the present embodiment and the operation of the first embodiment.

Note that, in the transmission device 100d illustrated in FIG. 15 described in the fifth embodiment, the combining unit 150 configures the data frame using the N first checksums acquired from the respective checksum calculation units 122 of the computers 120-1 to 120-N, but the present invention is not limited thereto. The combining unit 150 may include the checksum calculation unit 122 (not illustrated), perform a checksum calculation on the N first checksums calculated by the checksum calculation units 122 of the computers 120-1 to 120-N and acquired from the checksum calculation units 122 of the computers 120-1 to 120-N, and aggregate the N first checksums into one checksum. In this case, the combining unit 150 combines the aggregated one checksum and one piece of second data acquired from the calculation unit 131 of the computer 130 to form a data frame. The transmission unit 160 transmits the aggregated one first checksum and the one piece of second data to the reception device 200d.

In a case where the transmission device 100d has such a configuration, the reception unit 210 of the reception device 200d illustrated in FIG. 15 described in the fifth embodiment receives a data frame including one checksum aggregated by the checksum calculation unit 122 of the combining unit 150 included in the transmission device 100d and one piece of second data calculated by the calculation unit 131 of the computer 130 that is the second computer. The checksum calculation unit 220, which is the second checksum calculation unit, computes a plurality of second checksums for the second data with the same calculation method as the computation method performed by the checksum calculation units 122, which are the plurality of first checksum calculation units included in the computers 120-1 to 120-N of the transmission device 100d. Next, the checksum calculation unit 220 performs one checksum calculation on the plurality of calculated second checksums with the same calculation method as the calculation method performed by the checksum calculation unit 122 of the combining unit 150 included in the transmission device 100d, that is, the checksum calculation for aggregation into one checksum. The comparison unit 230 compares the one checksum aggregated by the transmission device 100 and included in the data frame with the one checksum aggregated as a computation result of the checksum calculation unit 220, and determines whether to adopt the second data.

### Sixth Embodiment

In the fifth embodiment, the case where the transmission device includes the plurality of computers 120 and the computers 120 perform similar calculations has been described. In the sixth embodiment, a case where the transmission device includes a plurality of computers 120 and the checksum calculation units 122 of the computers 120 perform different calculations will be described.

As in the fifth embodiment, a case where the present embodiment is applied to the configuration of the first embodiment will be specifically described. Note that in the sixth embodiment, the configuration of the communication system 300d is the same as the configuration of the communication system 300d in the fifth embodiment illustrated in FIG. 15. In the sixth embodiment, the configuration itself of the communication system 300d is the same as the configuration in the fifth embodiment, but in FIG. 15, the values of the N first checksums output from the respective checksum calculation units 122 of the computers 120-1 to 120-N are different values. More strictly, in FIG. 15, the output from the checksum calculation unit 220 of the reception device 200d to the comparison unit 230 is “a plurality of second checksums +second data” as will be described later. Hereinafter, the operation of the communication system 300d of the sixth embodiment will be described focusing on the difference from the operation of the communication system 300d of the fifth embodiment.

In the transmission device 100d, the first data normally calculated by each calculation unit 121 of the computers 120-1 to 120-N is [0xc0 0xA8 0xFF 0x58]. In the present embodiment, the checksum calculation units 122 of the computers 120-1 to 120-N calculate the first checksum with different calculation methods. For example, the checksum calculation unit 122 of the computer 120-1 calculates [0xBF] as the first checksum CS₁ with a calculation method adopting lower two bits of a result of simple addition of the first data. The checksum calculation unit 122 of the computer 120-2 calculates [0x40] as the first checksum CS₂ with a calculation method adopting the complement of one of the lower two bits of a result of simple addition of the first data. The checksum calculation unit 122 of the computer 120-3 (not illustrated) adopts a 2-bit cyclic redundancy check (CRC) code and calculates [0x02] as the first checksum CS₃ with a calculation method using 101 as a generator polynomial. The checksum calculation unit 122 of the computer 120-N adopts a 3-bit CRC code, and calculates [0x06] as the first checksum CS_{N} with a calculation method using 1001 as a generator polynomial. Note that the checksum calculation units 122 of the computers 120-1 to 120-N may use different generator polynomials with the same bit length.

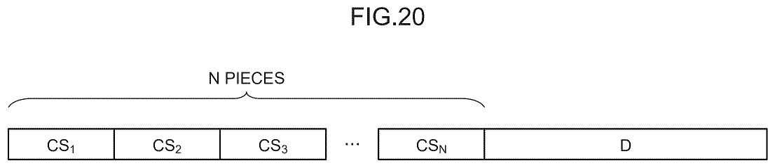

FIG. 20 is a diagram illustrating an example of a data frame including N first checksums and one piece of second data transmitted from the transmission device 100d of the communication system 300d to the reception device 200d according to the sixth embodiment. In FIG. 20, the first checksums are represented by CS₁ to CS_{N}, and the second data is represented by D. Note that, here, the order of the combined N first checksums and one piece of second data is the N first checksums and the one piece of second data, but the order may be the one piece of second data and the N first checksums as long as the order is known between the transmission device 100d and the reception device 200d. Applying the first checksums to the data frame in FIG. 20 results in [0xBF 0x40 0x02 . . . 0x06 0xc0 0xA8 0xFF 0x58] being transmitted from the transmission device 100d to the reception device 200d as the N first checksums and one piece of second data.

In the reception device 200d, the reception unit 210 outputs [0xBF 0x40 0x02 . . . 0x06] to the comparison unit 230 as a plurality of first checksums, here, N first checksums, among [0xBF 0x40 0x02 . . . 0x06 0xc0 0xA8 0xFF 0x58] which are the N first checksums and the one piece of second data received from the transmission device 100d, and outputs [0xc0 0xA8 0xFF 0x58] to the checksum calculation unit 220 as the second data.

The checksum calculation unit 220 calculates a plurality of second checksums, here, N second checksums, for [0xc0 0xA8 0xFF 0x58], which is the second data, with the same calculation method as each checksum calculation unit 122 included in the computers 120-1 to 120-N of the transmission device 100d, that is, with the same calculation method as the N calculation methods by the N checksum calculation units 122. In a case where the second data is normal and the calculation of the checksum calculation unit 220 is also normal, the checksum calculation unit 220 calculates N second checksums having the same value as the first checksums CS₁ to CS_{N} calculated by the checksum calculation units 122 included in the computers 120-1 to 120-N of the transmission device 100d, that is, [0xBF 0x40 0x02 . . . 0x06]. The checksum calculation unit 220 outputs the N second checksums and the one piece of second data to the comparison unit 230.

The comparison unit 230 compares [0xBF 0x40 0x02 . . . 0x06], which is the plurality of first checksums acquired from the reception unit 210, that is, the N first checksums, with the plurality of second checksums calculated by the checksum calculation unit 220, that is, the N second checksums. At this time, the comparison unit 230 compares the first checksum and the second checksum calculated with the same calculation method, that is, compares the first checksum and the second checksum for each calculation method. Here, the comparison unit 230 compares the first checksum and the second checksum in N combinations. In a case where the first checksum and the second checksum match in the comparison for each of all the calculation methods, the comparison unit 230 adopts the second data. In the comparison between the first checksum and the second checksum by the N calculation methods, if there is at least one checksum that does not match, the comparison unit 230 does not adopt the second data.

Note that the comparison unit 230 may adopt the second data in a case where the first checksums and the second checksums with the N calculation methods match at a prescribed ratio or more in comparison between the first checksums and the second checksums. That is, the comparison unit 230 may compare the first checksums and the second checksums for each of the N calculation methods, and determine whether to adopt the second data according to the matching ratio. As a result, as in the case of the fifth embodiment, even when a malfunction occurs in some of the computers 120-1 to 120-N of the transmission device 100d, the communication system 300d can take measures such as repair and replacement of the malfunctioning computer 120 among the computers 120-1 to 120-N included in the transmission device 100d while operating the transmission device 100d while adopting the second data in the reception device 200d if the number of the malfunctioning computers 120 is small.

As described above, in the present embodiment, in the transmission device 100d, the calculation units 121, which are the first calculation units included in the computers 120-1 to 120-N, which are the plurality of first computers, calculate the first data with the same calculation method. The checksum calculation units 122, which are the first checksum calculation units included in the computers 120-1 to 120-N, which are the plurality of first computers, calculate the first checksum with different calculation methods. The transmission unit 160 transmits, to the reception device 200d, the plurality of first checksums calculated by the checksum calculation units 122, which are the plurality of first checksum calculation units, and the one piece of second data.

In addition, in the reception device 200d, the reception unit 210 receives the plurality of first checksums calculated with different calculation methods in the checksum calculation units 122, which are the plurality of first checksum calculation units included in the transmission device 100d, and the one piece of second data. The checksum calculation unit 220, which is the second checksum calculation unit, computes a plurality of second checksums for the second data with a plurality of different computation methods that are the same as the plurality of different calculation methods performed by the checksum calculation units 122, which are the plurality of first checksum calculation units included in the transmission device 100d. The comparison unit 230 compares the first checksums and the second checksums calculated with the same calculation method for each calculation method, and determines whether to adopt the second data according to the matching ratio.

As described above, according to the present embodiment, in the communication system 300d, the transmission device 100d includes the plurality of computers 120-1 to 120-N, and the plurality of computers 120-1 to 120-N calculate the first checksum with different calculation methods and output the plurality of first checksums and one piece of second data. The reception device 200d calculates a plurality of second checksums using the second data with the plurality of calculation methods that are the same as the plurality of calculation methods in the transmission device 100d, compares the first checksums with the second checksums for each calculation method, and determines whether to adopt the second data. As a result, similarly to the communication system 300d of the fifth embodiment, the communication system 300d can prevent output of an erroneous calculation result when a part of the components of the communication system 300d malfunctions. Furthermore, in the sixth embodiment, in the communication system 300d, since the calculation methods of the first checksums in the plurality of computers 120-1 to 120-N of the transmission device 100d are different for each computer 120, it is possible to prevent a possibility that a software implementation error is duplicated, and it is possible to ensure higher reliability than in the fifth embodiment.

Although the case of the application to the configuration of the first embodiment has been described as an example, the present embodiment is also applicable to the second to fourth embodiments. As in the fifth embodiment, the configurations corresponding to the second to fourth embodiments are the configurations illustrated in FIGS. 17 to 19. However, as described above, the values of the N first checksums output from the respective checksum calculation units 122 of the computers 120-1 to 120-N have different values. More strictly, in FIGS. 17 to 19, the output from the checksum calculation unit 220 of the reception device 200d to the comparison unit 230 is “a plurality of second checksums +second data”.

Note that, in the transmission device 100d illustrated in FIG. 15 described in the sixth embodiment, the combining unit 150 configures the data frame using the N first checksums acquired from the respective checksum calculation units 122 of the computers 120-1 to 120-N, but the present invention is not limited thereto. As in the fifth embodiment, the combining unit 150 may include the checksum calculation unit 122 (not illustrated), perform a checksum calculation on the N first checksums calculated by the checksum calculation units 122 of the computers 120-1 to 120-N and acquired from the checksum calculation units 122 of the computers 120-1 to 120-N, and aggregate the N first checksums into one checksum. In this case, the combining unit 150 combines the aggregated one checksum and one piece of second data acquired from the calculation unit 131 of the computer 130 to form a data frame. The transmission unit 160 transmits the aggregated one first checksum and the one piece of second data to the reception device 200d.

In a case where the transmission device 100d has such a configuration, the reception unit 210 of the reception device 200d illustrated in FIG. 15 described in the sixth embodiment receives a data frame including one checksum aggregated by the checksum calculation unit 122 of the combining unit 150 included in the transmission device 100d and one piece of second data calculated by the calculation unit 131 of the computer 130 that is the second computer. The checksum calculation unit 220, which is the second checksum calculation unit, calculates a plurality of second checksums for the second data with the same calculation method as the calculation method performed by the checksum calculation unit 122, which is a plurality of first checksum calculation units included in the computers 120-1 to 120-N of the transmission device 100d, that is, with the same calculation method as the N calculation methods by the N checksum calculation units 122. Next, the checksum calculation unit 220 performs one checksum calculation on the plurality of calculated second checksums with the same calculation method as the calculation method performed by the checksum calculation unit 122 of the combining unit 150 included in the transmission device 100d, that is, the checksum calculation for aggregation into one checksum. The comparison unit 230 compares the one checksum aggregated by the transmission device 100 and included in the data frame with the one checksum aggregated as a computation result of the checksum calculation unit 220, and determines whether to adopt the second data.

### Seventh Embodiment

In the fifth embodiment and the sixth embodiment, in the example of FIG. 15, the transmission device 100d includes a plurality of computers 120 which are first computers, and transmits the first checksum output from each computer 120 to the reception device 200d. Therefore, as the number of first checksums transmitted from the transmission device 100d to the reception device 200d increases, the amount of data increases and the communication time also increases in the data frame transmitted from the transmission device 100d to the reception device 200d. In the seventh embodiment, a case will be described in which the transmission device includes a plurality of computers 120 as the first computers while mitigating an increase in the data amount of the data frame transmitted from the transmission device to the reception device.

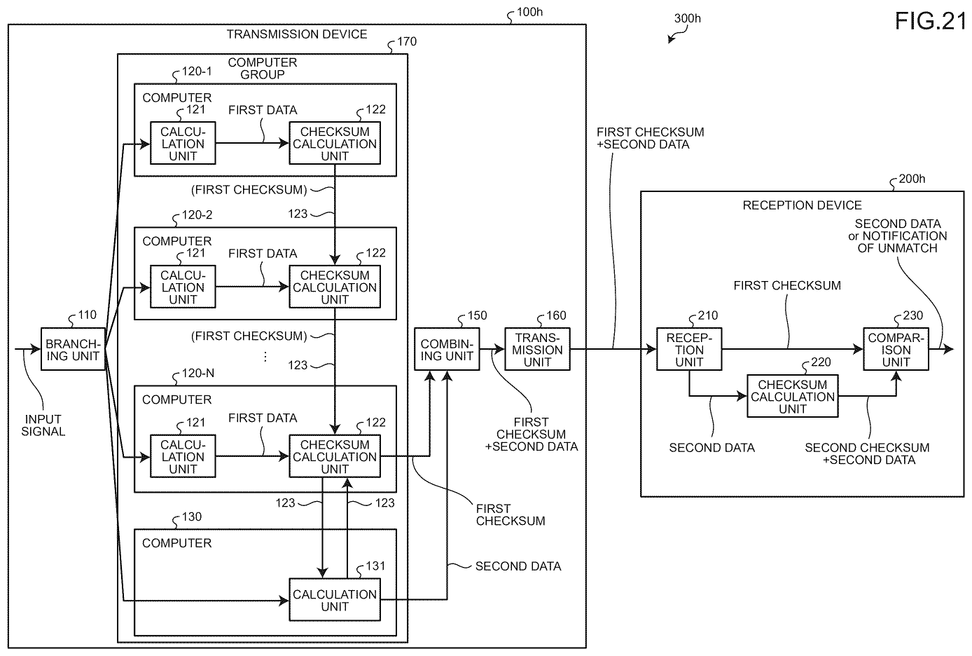

FIG. 21 is a diagram illustrating an exemplary configuration of a communication system 300h according to the seventh embodiment. The communication system 300h includes a transmission device 100h and a reception device 200h. The application of the communication system 300h is similar to that of the communication system 300 of the first embodiment. The transmission device 100h includes the branching unit 110, a computer group 170, the combining unit 150, and the transmission unit 160. The computer group 170 includes the computers 120-1 to 120-N that are first computers and the computer 130 that is a second computer. Similarly to the transmission device 100d and the like described in the fifth and sixth embodiments, the computer group 170 includes the computers 120-1 to 120-N that are N first computers and the computer 130 that is one second computer. However, in the computer group 170, the first checksum calculation method and output method are different from those of the transmission device 100d and the like described in the fifth embodiment and the sixth embodiment.

The operation of the transmission device 100h will be described focusing on the difference from the transmission devices of the first to sixth embodiments.

In the computer group 170, each of the calculation units 121 of the computers 120-1 to 120-N calculates the first data with a calculation method similar to the calculation methods described above. In the computer group 170, the computers 120-1 to 120-N are connected in series by the timing adjustment interface 123 as illustrated in FIG. 21. In the present embodiment, the checksum calculation unit 122 of the computer 120-1 calculates the first checksum with the same calculation method as before, but outputs the calculated first checksum to the checksum calculation unit 122 of the computer 120-2 in the subsequent stage. In the present embodiment, the checksum calculation unit 122 of the computer 120-1 to 120-(N−1) outputs the first checksum to the checksum calculation unit 122 of the computer 120 in the subsequent stage via the timing adjustment interface 123. In addition, the checksum calculation unit 122 of the computer 120-2 to 120-N calculates the first checksum using the first data calculated by the calculation unit 121 of the same computer 120 and the first checksum calculated by the checksum calculation unit 122 of the computer 120 in the preceding stage acquired via the timing adjustment interface 123. The checksum calculation unit 122 of the computer 120-N outputs the calculated first checksum to the combining unit 150.

Note that the input/output of the first checksum between the checksum calculation units 122 of the computers 120-1 to 120-N may be performed using another interface (not illustrated) instead of the timing adjustment interface 123.

The combining unit 150 combines the first checksum acquired from the checksum calculation unit 122 of the computer 120-N and the second data acquired from the calculation unit 131 of the computer 130. The combining unit 150 outputs the combined first checksum and second data to the transmission unit 160. The transmission unit 160 acquires the combined first checksum and second data from the combining unit 150, and transmits the combined first checksum and second data to the reception device 200h.

The operation of the reception device 200h will be described. As in the case of the first embodiment and the like, when receiving the combined first checksum and second data from the transmission device 100h, the reception unit 210 outputs the first checksum to the comparison unit 230 and outputs the second data to the checksum calculation unit 220. The checksum calculation unit 220 performs, on the second data, a second checksum calculation a plurality of times under the same condition as the condition when the checksum calculation unit 122, which is a plurality of first checksum calculation units of the computer group 170 included in the transmission device 100h, computes the first checksum, and outputs one finally obtained second checksum to the comparison unit 230. In the reception device 200h, the operation of comparison unit 230 is similar to the operation of comparison unit 230 such as the reception device 200 of the first embodiment.

Here, suppose that some failure has occurred in a part of the components in the communication system 300h. For example, in a case where one or more of the computers 120-1 to 120-N included in the transmission device 100h has malfunctioned, the first checksum output from the malfunctioning computer 120 has a value different from the original first checksum output when the computer 120 does not malfunction. Therefore, the first checksum calculated by the computers 120 subsequent to the malfunctioning computer 120 also has a value different from the original first checksum even when the computers 120 subsequent to the malfunctioning computer 120 do not malfunction. In this case, since the comparison unit 230 of the reception device 200h determines that the first checksums do not match the second checksum, the second data is not adopted.

In addition, in a case where the computer 130 included in the transmission device 100h has malfunctioned, the second checksum calculated by the checksum calculation unit 220 of the reception device 200h has a value different from the first checksum calculated by the computer 120-N of the transmission device 100h. Also in this case, since the comparison unit 230 of the reception device 200h determines that the first checksums do not match the second checksum, the second data is not adopted.

In addition, when the combining unit 150 of the transmission device 100h has malfunctioned, the first checksum and the second data are not correctly combined, so that the reception device 200h cannot receive the first checksum and the second data from the transmission device 100h. Also in this case, the second data is not adopted in the reception device 200h.

In addition, in a case where the reception device 200h has malfunctioned, the first checksums cannot be compared with the second checksum, and thus the second data is not adopted.

As described above, the communication system 300h can prevent output of an erroneous calculation result when a failure occurs in any component.

As described above, in the present embodiment, the transmission device 100h includes the plurality of computers 120 as the first computers, and the computers 120 as the plurality of first computers are connected in series while being connected such that input signals are input to the respective computers. The calculation unit 121, which is the first calculation unit included in the computers 120, which are the plurality of first computers, calculates the first data. The checksum calculation unit 122, which is the first checksum calculation unit included in the computers 120, which are the plurality of first computers, calculates the first checksum by using the first data calculated by the calculation unit 121, which is the first calculation unit of the computer 120, which is the same first computer, and the first checksum calculated by the checksum calculation unit 122 which is the first checksum calculation unit of the computer 120 which is the first computer in the preceding stage, except for the checksum calculation unit 122 which is the first checksum calculation unit of the computer 120-1 which is the foremost first computer among the computers 120-1 to 120-N, which are the plurality of first computers connected in series. The transmission unit 160 transmits the first checksum and the second data to the reception device 200h, the first checksum being calculated by the checksum calculation unit 122 that is the first checksum calculation unit of the computer 120-N, which is the first computer in the last stage among the computers 120-1 to 120-N, which are the plurality of first computers connected in series.

In addition, in the reception device 200h, the checksum calculation unit 220, which is the second checksum calculation unit, performs a second checksum calculation on the second data a plurality of times under the same condition as the condition when the checksum calculation unit 122, which is a plurality of first checksum calculation units included in the transmission device 100h, calculates the first checksum, and outputs one finally obtained second checksum to the comparison unit 230. The comparison unit 230 uses one second checksum finally obtained by the checksum calculation unit 220, which is the second checksum calculation unit, for comparison with the first checksum.

As described above, according to the present embodiment, in the communication system 300h, the transmission device 100h includes the plurality of computers 120-1 to 120-N, and among the plurality of computers 120-1 to 120-N, the computers 120-2 to 120-N calculate the first checksum using the first data and the first checksum calculated by the computer 120 in the preceding stage, and the first checksum calculated by the computer 120-N at the last stage and the second data calculated by the computer 130 are output. The reception device 200h calculates the second checksum using the second data with the same calculation method as the calculation method of the first checksum in the transmission device 100h, compares the first checksum with the second checksum, and determines whether to adopt the second data. As a result, the communication system 300h mitigates an increase in the amount of data from the transmission device 100h to the reception device 200h, and can improve the detection accuracy of the failure in the data calculation as compared with the communication system 300 of the first embodiment by making the computer 120 redundant.

Although the characteristic operation in the present embodiment has been described using an example of application to the configuration of the first embodiment, the present embodiment is also applicable to the second to fourth embodiments.

### Eighth Embodiment

In the eighth embodiment, a case where the transmission device includes a plurality of computer groups 170, a plurality of combining units 150, and a plurality of transmission units 160 will be described.

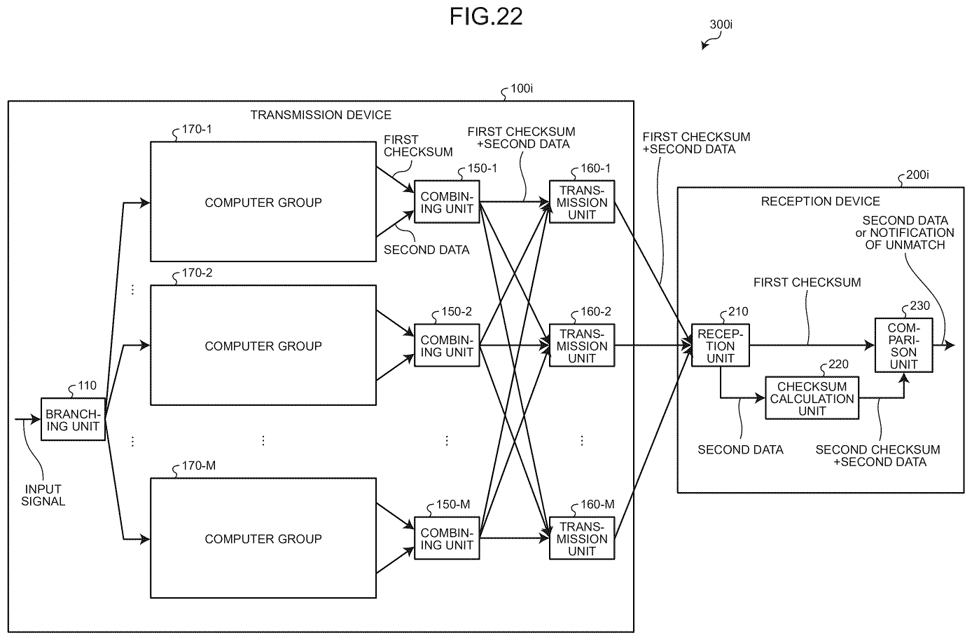

FIG. 22 is a diagram illustrating an exemplary configuration of a communication system 300i according to the eighth embodiment. The communication system 300i includes a transmission device 100i and a reception device 200i. The application of the communication system 300i is similar to that of the communication system 300 of the first embodiment. The transmission device 100i includes the branching unit 110, computer groups 170-1 to 170-M, combining units 150-1 to 150-M, and transmission units 160-1 to 160-M. Note that M is an integer of two or more. In the following description, the computer groups 170-1 to 170-M may be referred to as the computer group 170 when not distinguished, the combining units 150-1 to 150-M may be referred to as the combining unit 150 when not distinguished, and the transmission units 160-1 to 160-M may be referred to as the transmission unit 160 when not distinguished. In the example of FIG. 22, in the transmission device 100i, the number of computer groups 170, the number of combining units 150, and the number of transmission units 160 are the same, but the number of transmission units 160 may be different from the number of computer groups 170 and the number of combining units 150. In the present embodiment, the configuration of the computer groups 170-1 to 170-M is the same as the configuration of the computer group 170 included in the transmission device 100h described in the seventh embodiment illustrated in FIG. 21.

The operation of the transmission device 100i will be described focusing on the difference from the transmission devices of the first to seventh embodiments.

The branching unit 110 branches the input signal by the number of computers included in the transmission device 100i, and outputs the input signals to the respective computers. In a case where the transmission device 100i includes M computer groups 170 as illustrated in FIG. 22, and each computer group 170 includes N computers 120 and one computer 130 as illustrated in FIG. 21, the branching unit 110 branches the input signal into (N+1)×M.

The operation of the computer group 170 is the same as the operation of the computer group 170 described in the seventh embodiment. In the eighth embodiment, each computer group 170 of the computer groups 170-1 to 170-M performs the same operation.

Similarly to the above, the combining unit 150 combines the first checksum acquired from the checksum calculation unit 122 of the computer 120-N and the second data acquired from the calculation unit 131 of the computer 130. In the present embodiment, the combining unit 150 duplicates the combined first checksum and second data by the number of the transmission units 160 included in the transmission device 100i and outputs the duplicated data to each of the transmission units 160.

The transmission unit 160 acquires the combined first checksum and second data from each combining unit 150. The transmission unit 160 calculates a final second checksum corresponding to the acquired first checksum by performing a calculation similar to that of the computers 120-1 to 120-N included in the computer group 170 to which the first checksum and the second data are output using the second data for the combination of the combined first checksum and second data acquired from each combining unit 150. When the acquired first checksum and the second checksum calculated by the transmission unit 160 match, the transmission unit 160 transmits the acquired combination of the first checksum and second data to the reception device 200i. However, upon a calculation using the combination of the first checksum and second data acquired from each of the combining units 150, in a case where there is a plurality of combinations of the first checksum and the second data in which the acquired first checksum and the second checksum calculated by the transmission unit 160 match, the transmission unit 160 transmits any one of the combinations of the first checksum and the second data to the reception device 200i.

Note that, in a case where the combination of the first checksum and the second data acquired from each of the combining units 150 has the same content, and the acquired first checksum and the second checksum calculated by the transmission unit 160 do not match, the transmission unit 160 may select one from the acquired combinations of the first checksum and second data and transmit the selected combination to the reception device 200i on the assumption that there is a high possibility that the calculation thereof is incorrect. In addition, also in a case where the combination of the first checksum and the second data acquired from each of the combining units 150 has the same content at a prescribed ratio or more, the transmission unit 160 may determine that the combination of the first checksum and the second data having the same content is highly likely to be a correct calculation result regardless of the comparison result between the acquired first checksum and the second checksum calculated by the transmission unit 160, select one from the combinations of the first checksum and the second data having the same content, and transmit the selected combination to the reception device 200i.

Note that, in the present embodiment, the transmission unit 160 performs the calculation processing and the comparison processing as described above, but in a case where the transmission device 100i includes the combining unit 150 as in the present embodiment, the combining unit 150 may perform the calculation processing and the comparison processing.

In the transmission device 100i, the redundancy increases as the number of computer groups 170-1 to 170-M increases, but if the number of transmission units 160-1 to 160-M is too large, the amount of data from the transmission device 100i to the reception device 200i increases. Therefore, M may be two.

The operation of the reception device 200i will be described. In the first to seventh embodiments, the reception unit 210 of the reception device receives only one combination of the first checksum and the second data. On the other hand, in the present embodiment, the reception unit 210 of the reception device 200i may receive a plurality of combinations of the first checksum and the second data from the transmission device 100i. Specifically, in the example of FIG. 22, the reception unit 210 of the reception device 200i may receive M combinations of the first checksum and the second data corresponding to the number of transmission units 160 included in the transmission device 100i at the maximum. However, even in a case where a plurality of combinations of the first checksum and the second data is transmitted from the transmission device 100i, the contents of the plurality of combinations of the first checksum and the second data are likely to be the same. Therefore, when receiving a plurality of combinations of the first checksum and the second data, the reception unit 210 of the reception device 200i only needs to adopt any one of the combinations, for example, the combination of the first checksum and the second data received first.

In the reception device 200i, the operations of the checksum calculation unit 220 and the comparison unit 230 are similar to the operations of the checksum calculation unit 220 and the comparison unit 230 of the reception device 200h of the seventh embodiment.

Here, suppose that some failure has occurred in a part of the components in the communication system 300i. For example, in a case where one or more computer groups 170 among the computer groups 170-1 to 170-M included in the transmission device 100i has malfunctioned, the first checksum output from the malfunctioning computer group 170 has a value different from the original first checksum output when the computer group 170 does not malfunction. In this case, the first checksum and the second data output from the malfunctioning computer group 170 are not adopted in the transmission unit 160 of the transmission device 100i.

In addition, when the combining unit 150 of the transmission device 100i has malfunctioned, the first checksum and the second data are not correctly combined. Therefore, in the transmission unit 160 of the transmission device 100i, the first checksum and the second data that are not correctly combined are not adopted.

In addition, in a case where the reception device 200i has malfunctioned, the first checksums cannot be compared with the second checksum, and thus the second data is not adopted.

As described above, the communication system 300i can prevent output of an erroneous calculation result when a failure occurs in any component.

As described above, in the present embodiment, the transmission device 100i includes the plurality of computer groups 170 including the plurality of computers 120-1 to 120-N, which are a plurality of first computers connected in series, and the computer 130, which is one second computer, and further includes the plurality of transmission units 160. In each of the computer groups 170 of the plurality of computer groups 170-1 to 170-M, the computers 120-1 to 120-N, which are the plurality of first computers, are connected such that input signals are input to the respective computers, and are connected in series. The calculation unit 121, which is the first calculation unit included in each of the computers 120-1 to 120-N, which are the plurality of first computers, calculates the first data. The checksum calculation unit 122, which is the first checksum calculation unit included in the computers 120-1 to 120-N, which are the plurality of first computers, calculates the first checksum by using the first data calculated by the calculation unit 121, which is the first calculation unit of the computer 120, which is the same first computer, and the first checksum calculated by the checksum calculation unit 122 which is the first checksum calculation unit of the computer 120 which is the first computer in the preceding stage, except for the checksum calculation unit 122 which is the first checksum calculation unit of the computer 120-1 which is the foremost first computer among the computers 120-1 to 120-N, which are the plurality of first computers connected in series. In the plurality of transmission units 160-1 to 160-M, each transmission unit 160 acquires, from each computer group 170, the first checksum calculated by the checksum calculation unit 122 that is the first checksum calculation unit of the computer 120-N that is the first computer in the last stage of the computers 120-1 to 120-N that are the plurality of computers connected in series, and the second data, compares the acquired first checksum with the second checksum finally obtained by performing the second checksum calculation using the second data a plurality of times with the same calculation method as the calculation method of the first checksum performed in each computer group 170, and determines the first checksum and the second data to be transmitted to the reception device 200i based on the comparison result.

In addition, in the reception device 200i, when receiving the first checksum and the second data from the transmission device 100i a plurality of times, the reception unit 210 adopts one of the plurality of received first checksums and second data. The checksum calculation unit 220, which is the second checksum calculation unit, performs a second checksum calculation on the second data a plurality of times under the same condition as the condition when the checksum calculation unit 122, which is a plurality of first checksum calculation units of the computer group 170 included in the transmission device 100i, calculates the first checksum, and outputs one finally obtained second checksum to the comparison unit 230. The comparison unit 230 uses one second checksum finally obtained by the checksum calculation unit 220, which is the second checksum calculation unit, for comparison with the first checksum.

As described above, according to the present embodiment, in the communication system 300i, the transmission device 100i includes the plurality of computer groups 170-1 to 170-M, the plurality of combining units 150-1 to 150-M, and the transmission units 160-1 to 160-M, and transmits one combination determined as the appropriate first checksum and second data by the transmission units 160-1 to 160-M from each transmission unit 160 to the reception device 200i. When a plurality of first checksums and a plurality of second data are received, the reception device 200i adopts only one checksum, calculates the second checksum using the second data with the same calculation method as the calculation method of the first checksum in the transmission device 100i, compares the first checksum with the second checksum, and determines whether to adopt the second data. As a result, even when a malfunction occurs in any of the computer groups 170, the communication system 300i can take measures such as repair and replacement of the malfunctioning computer group 170 among the computer groups 170-1 to 170-M included in the transmission device 100i while operating the transmission device 100i.

Note that, in the present embodiment, when M=2 and each of the transmission units 160-1 to 160-2 acquires two combinations of the first checksum and the second data acquired from the combining units 150-1 to 150-2, that is, four combinations of the first checksum and the second data as the transmission units 160-1 to 160-2, the transmission units 160-1 to 160-2 may transmit all combinations of the first checksum and the second data to the reception device 200i without performing the above-described checksum calculation processing and comparison processing. In this case, although the processing load on the reception device 200i increases, the processing load on the transmission device 100i can be reduced.

Although the characteristic operation in the present embodiment has been described using an example of application to the configuration of the first embodiment, the present embodiment is also applicable to the second to fourth embodiments.

The configurations described in the above-mentioned embodiments indicate examples. The embodiments can be combined with another well-known technique and with each other, and some of the configurations can be omitted or changed in a range not departing from the gist.

### Reference Signs List

100, 100a, 100b, 100c, 100d, 100e, 100f, 100g, 100h, 100i transmission device; 110 branching unit; 111 duplication serial number assigning unit; 120, 120-1 to 120-N, 130 computer; 121, 131 calculation unit; 122, 220 checksum calculation unit; 123 timing adjustment interface; 141 identification information generation unit; 150, 150-1 to 150-M combining unit; 160, 160-1 to 160-M transmission unit; 170, 170-1 to 170-M computer group; 200, 200d, 200h, 200i reception device; 210 reception unit; 230 comparison unit; 300, 300a, 300b, 300c, 300d, 300e, 300f, 300g, 300h, 300i communication system; 900, 903 processing circuitry; 901 processor; 902 memory.

1. A transmission device comprising:
a first computer including a first calculator to calculate first data by performing a calculation on an input signal, and a first checksum calculator to calculate a first checksum by performing a calculation on the first data;
a second computer including a second calculator to calculate second data by performing a calculation on the input signal; and
a transmitter to transmit the first checksum and the second data to a reception device.

2. The transmission device according to claim 1, comprising
a combining circuitry to combine the first checksum and the second data, wherein
the first computer and the second computer use a timing adjustment interface to adjust a timing at which the first checksum calculator outputs the first checksum and a timing at which the second calculator outputs the second data, and
the transmitter transmits the first checksum and the second data combined by the combining circuitry to the reception device.

3. The transmission device according to claim 1, wherein
the first computer includes a first identification information generation circuitry to generate identification information for the first data,
the second computer includes second identification information generation circuitry to generate identification information for the second data,
the first identification information generation circuitry and the second identification information generation circuitry generate the identification information with a prescribed generation method such that the same identification information is generated for the first data and the second data that are based on the same input signal,
the first checksum calculator assigns the identification information to the first data calculated by the first calculator to calculate and output the first checksum,
the second calculation calculator assigns the identification information to the second data calculated and outputs the second data, and
the transmitter transmits the first checksum calculated from the first data assigned with the identification information to the reception device, and transmits the second data assigned with the identification information to the reception device.

4. The transmission device according to claim 1, wherein
the first computer includes first duplication serial number assigning circuitry to assign serial numbers to input signals obtained by duplicating the input signal and outputs the input signals to the first calculator,
the second computer includes second duplication serial number assigning circuitry to assign serial numbers to input signals obtained by duplicating the input signal and outputs the input signals to the second calculator,
the first calculator calculates the first data by performing a calculation on each of the input signals duplicated having different serial numbers,
the first checksum calculator calculates the first checksum by performing a calculation on each of a plurality of pieces of the first data, and
the second calculator calculates the second data by performing a calculation on each of the input signals duplicated having different serial numbers.

5. The transmission device according to claim 1, comprising
a plurality of the first computers, wherein
the first calculators included in the plurality of first computers calculate the first data with the same calculation method,
the first checksum calculators included in the plurality of first computers calculate the first checksum with the same calculation method, and
the transmitter transmits the plurality of first checksums calculated by the plurality of first checksum calculators and one piece of the second data to the reception device.

6. The transmission device according to claim 2, comprising
a plurality of the first computers, wherein
the first calculators included in the plurality of first computers calculate the first data with the same calculation method,
the first checksum calculators included in the plurality of first computers calculate the first checksum with the same calculation method,
the combining circuitry performs a checksum calculation on a plurality of the first checksums calculated by the plurality of first checksum calculators to aggregate the plurality of first checksums into one checksum, and
the transmitter transmits the one checksum aggregated and one piece of the second data to the reception device.

7. The transmission device according to claim 1, comprising
a plurality of the first computers, wherein
the first calculators included in the plurality of first computers calculate the first data with the same calculation method,
the first checksum calculators included in the plurality of first computers calculate the first checksum with different calculation methods, and
the transmitter transmits a plurality of the first checksums calculated by the plurality of first checksum calculators and one piece of the second data to the reception device.

8. The transmission device according to claim 2, comprising
a plurality of the first computers, wherein
the first calculators included in the plurality of first computers calculate the first data with the same calculation method,
the first checksum calculators included in the plurality of first computers calculate the first checksum with different calculation methods,
the combining circuitry performs a checksum calculation on a plurality of the first checksums calculated by the plurality of first checksum calculators to aggregate the plurality of first checksums into one checksum, and
the transmitter transmits the one checksum aggregated and one piece of the second data to the reception device.

9. The transmission device according to claim 1, comprising
a plurality of the first computers, the plurality of first computers being connected in series and to receive input of the input signal,
each of the first calculators included in the plurality of first computers calculates the first data,
each of the first checksum calculators included in the plurality of first computers calculates the first checksum by using the first data calculated by the first calculator of the same first computer and a first checksum calculated by a first checksum calculator of a first computer in a preceding stage, except for a first checksum calculator of a first computer in a foremost stage of the plurality of first computers connected in series, and
the transmitter transmits the first checksum calculated by a first checksum calculator of a first computer in a last stage of the plurality of first computers connected in series and the second data to the reception device.

10. The transmission device according to claim 1, further comprising:
a plurality of computer groups each including a plurality of the first computers connected in series and one second computer; and
a plurality of the transmitters, wherein
in each computer group of the plurality of computer groups, the plurality of first computers are connected in series and to receive input of the input signal,
each of the first calculators included in the plurality of first computers calculates the first data,
each of the first checksum calculators included in the plurality of first computers calculates the first checksum by using the first data calculated by the first calculator of the same first computer and a first checksum calculated by a first checksum calculator of a first computer in a preceding stage, except for a first checksum calculator of a first computer in a foremost stage of the plurality of first computers connected in series, and in the plurality of transmitters, each transmitter acquires a first checksum calculated by a first checksum calculator of a first computer in a last stage of the plurality of first computers connected in series and the second data from each computer group, compares the first checksum acquired with a second checksum finally obtained by performing a second checksum calculation a plurality of times using the second data with the same calculation method as the calculation method of the first checksum performed by each computer group, and determines the first checksum and the second data to be transmitted to the reception device based on a comparison result.

11. A reception device comprising:
a receiver to receive a first checksum calculated from first data and second data transmitted from the transmission device according to claim 1;
a second checksum calculator to calculate a second checksum by performing a calculation on the second data; and
comparison circuitry to compare the first checksum and the second checksum, and adopt the second data when the first checksum and the second checksum match.

12. The reception device according to claim 11, wherein
in a case where identification information is assigned to the second data, the second checksum calculator calculates the second checksum by performing a calculation on the second data assigned with the identification information and outputs the second checksum to the comparison circuitry, and
the comparison circuitry compares the second checksum with the first checksum calculated from the first data assigned with the same identification information as the identification information assigned to the second data, and adopts the second data when the first checksum and the second checksum match.

13. The reception device according to claim 11, wherein
the second checksum calculator calculates the second checksum by performing a calculation on all the second data that are based on the same input signal in a case where an input signal is duplicated in the transmission device, serial numbers are assigned to the input signals, the first checksum is calculated for each of the input signals duplicated having different serial numbers in a first computer of the transmission device, and the second data is calculated for each of the input signals duplicated having different serial numbers in a second computer of the transmission device, and
the comparison circuitry compares the first checksum and the second checksum for each of the serial numbers, and adopts the second data when all match.

14. The reception device according claim 11, wherein
the receiver receives a plurality of the first checksums calculated with the same calculation method in a plurality of first checksum calculators included in the transmission device, and one piece of the second data,
the second checksum calculator calculates one second checksum for the second data with the same calculation method as a calculation method performed by the plurality of first checksum calculation calculators included in the transmission device, and
the comparison circuitry compares the plurality of first checksums with the one second checksum, and determines whether to adopt the second data according to a matching ratio.

15. The reception device according to claim 11, wherein
the receiver receives a checksum and one piece of the second data, the checksum being obtained by aggregating a plurality of the first checksums calculated with the same calculation method in a plurality of first checksum calculators included in the transmission device into one checksum through a further checksum calculation at the transmission device,
the second checksum calculator calculates a plurality of the second checksums for the second data with the same calculation method as the calculation method performed by the plurality of first checksum calculators included in the transmission device, and aggregates the plurality of second checksums into one checksum through a further checksum calculation with the same calculation method as the calculation method performed by the transmission device, and
the comparison circuitry compares the one checksum aggregated by the transmission device with the one checksum aggregated by the second checksum calculator, and determines whether to adopt the second data.

16. The reception device according to claim 11, wherein
the receiver receives a plurality of the first checksums calculated with different calculation methods in a plurality of first checksum calculators included in the transmission device, and one piece of the second data,
the second checksum calculator calculates a plurality of the second checksums for the second data with a plurality of different calculation methods that are the same as the plurality of different calculation methods performed by the plurality of first checksum calculators included in the transmission device, and
the comparison circuitry compares, for each calculation method, the first checksums and the second checksums calculated with the same calculation methods, and determines whether to adopt the second data according to a matching ratio.

17. The reception device according to claim 11, wherein
the receiver receives a checksum and one piece of the second data, the checksum being obtained by aggregating a plurality of the first checksums calculated with different calculation methods in a plurality of first checksum calculators included in the transmission device into one checksum through a further checksum calculation at the transmission device,
the second checksum calculator calculates a plurality of the second checksums for the second data with a plurality of different calculation methods that are the same as the plurality of different calculation methods performed by the plurality of first checksum calculators included in the transmission device, and aggregates the plurality of second checksums into one checksum through a further checksum calculation with the same calculation method as the calculation method performed by the transmission device, and
the comparison circuitry compares the one checksum aggregated by the transmission device with the one checksum aggregated by the second checksum calculator, and determines whether to adopt the second data.

18. The reception device according to claim 11, wherein
the second checksum calculator performs a second checksum calculation on the second data a plurality of times under the same condition as a condition when the plurality of first checksum calculators included in the transmission device calculates the first checksum, and outputs one finally obtained second checksum to the comparison circuitry.

19. The reception device according to claim 18, wherein
when receiving the first checksum and the second data from the transmission device a plurality of times, the receiver adopts one of the plurality of first checksums and second data received.

20-58. (canceled)
